(19) United States
(12) Patent Application Publication
(10) Pub. No.: US 2008/0168441 A1
(43) Pub. Date: Jul. 10, 2008

(54) DATA PROCESSING APPARATUS, IMAGE PROCESSING APPARATUS, DATA PROCESSING METHOD, AND COMPUTER-READABLE RECORDING MEDIUM

(76) Inventor: Takahiro IMAMICHI, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/956,860

(22) Filed: Dec. 14, 2007

(30) Foreign Application Priority Data
Dec. 20, 2006 (JP) 2006-343086

(51) Int. Cl. G06F 9/46

(52) U.S. Cl. 718/100

(57) ABSTRACT

A data processing apparatus including a data inputting part for inputting target data, a data processing part for processing the target data input by the data inputting part, and a data outputting part for outputting the target data processed by the data processing part is disclosed that includes an interface for receiving a request for obtaining the target data to be input to the data inputting part, a view generating part for generating a view that obtains the target data from data managed in the data processing apparatus or data managed in a system connected to the data processing apparatus in accordance with the request received by the interface, and a view executing part for executing the view generated by the view generating part.

### BACKGROUND OF THE INVENTION

1. Field of the Invention

The present invention relates to a data processing apparatus, a data processing method, an image processing apparatus, and a computer-readable recording medium for managing/operating various data managed in an apparatus or a system connected to the apparatus.

2. Description of the Related Art

A digital multifunction machine (MFP, Multifunction Printer), which is known to be a typical image processing apparatus in these recent years, has application functions and communication functions such as a copier function, a facsimile function, a scanner function, and a printer function. Not only can this kind of image processing apparatus be used for a single user (one apparatus per user) but may also be used for plural users (one apparatus per n users) by using the image processing apparatus as an element of a system. That is, there are more situations where the image processing apparatus is used by connecting to a network connected to plural personal computers (PCs) used by plural users and various data processing apparatuses having a communication function (e.g., management server). Therefore, the image processing apparatus not only contains its own unique data but various kinds of data (e.g., valuable user data) obtained by serving as an element of the system (network).

However, this leads to a problem where plural “user names” (user identifiers) included in, for example, the attributes of user data (e.g., address data, account data, and mail data) are managed/operated by image processing apparatuses and management servers located at plural locations in the system. In other words, redundant data having the same content are managed/operated. Accordingly, in a case of changing a “user name”, there is a problem that all of the data including address data, account data, and mail data have to be changed at the same time. Thus, it is extremely difficult to manage (attain) conformity of data having the same attribute where various data are managed/operated in the system. It is particularly complicated since the data included in user data are frequently changed.

For example, Japanese Laid-Open Patent Application No. 2005-259111 proposes an image processing apparatus having a function of combining user data that are managed/operated at plural scattered locations.

The function of combining user data with use of the Japanese Laid-Open Patent Application No. 2005-259111 may be effective for resolving problems such as lack of data conformity or complicated procedures during updating. However, in addition to resolving such problems, it is also desired to resolve the task of providing data in view of easy accessibility for the user (including other applications operating in other apparatuses connected to the system).

### SUMMARY OF THE INVENTION

The present invention may provide a data processing apparatus, a data processing method, an image processing apparatus, and a computer-readable recording medium that substantially obviates one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by a data processing apparatus, a data processing method, an image processing apparatus, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides a data processing apparatus including a data inputting part for inputting target data, a data processing part for processing the target data input by the data inputting part, and a data outputting part for outputting the target data processed by the data processing part, the data processing apparatus including: an interface for receiving a request for obtaining the target data to be input to the data inputting part; a view generating part for generating a view that obtains the target data from data managed in the data processing apparatus or data managed in a system connected to the data processing apparatus in accordance with the request received by the interface; and a view executing part for executing the view generated by the view generating part.

Furthermore, another embodiment of the present invention provides an image processing apparatus including: the data processing apparatus according to an embodiment of the present invention.

Furthermore, another embodiment of the present invention provides a data processing method including a data inputting step for inputting target data, a data processing step for processing the target data input in the data inputting step, and a data outputting step for outputting the target data processed in the data processing step, the data processing method including the steps of: a) receiving a request for obtaining the target data to be input in the data inputting step; b) generating a view that obtains the target data from data managed in a data processing apparatus or data managed in a system connected to the data processing apparatus in accordance with the request received in step a); and c) executing the view generated in step b).

Furthermore, another embodiment of the present invention provides 10. A computer-readable recording medium on which a program for causing a computer to execute a data processing method including a data inputting step for inputting target data, a data processing step for processing the target data input in the data inputting step, and a data outputting step for outputting the target data processed in the data processing step, the data processing method including the steps of: a) receiving a request for obtaining the target data to be input in the data inputting step; b) generating a view that obtains the target data from data managed in a data processing apparatus or data managed in a system connected to the data processing apparatus in accordance with the request received in step a); and c) executing the view generated in step b).

Other objects, features and advantages of the present invention will become more apparent from the following detailed description when read in conjunction with the accompanying drawings.

### BRIEF DESCRIPTION OF THE DRAWINGS

FIG. 1 is a schematic diagram showing a hardware configuration of an image processing apparatus according to an embodiment of the present invention;

FIG. 2 is schematic diagram for describing problems of the conventional art;

FIG. 3 is a schematic diagram for describing one characteristic of a data obtaining function according to an embodiment of the present invention;

FIG. 4 is a schematic diagram showing an example of a data configuration of user data according to an embodiment of the present invention;

FIG. 5 is a schematic diagram for describing another characteristic of a data obtaining function according to an embodiment of the present invention;

FIG. 6 is a schematic diagram showing an example of a display of a user interface (UI) used for setting the controls for a data inputting step, a data processing step, and a data outputting step in a report outputting operation according to an embodiment of the present invention;

FIG. 7 is a schematic diagram showing an example of a software configuration of an image processing apparatus according to an embodiment of the present invention;

FIG. 8A is a schematic diagram for describing a pipe & filter concept according to an embodiment of the present invention;

FIG. 8B is a schematic diagram showing an example of elements included in a filter according to an embodiment of the present invention;

FIG. 9 is a flowchart showing the basic steps (operations) of an image processing apparatus according to an embodiment of the present invention (Part 1);

FIG. 10 is a flowchart showing the basic steps (operations) of an image processing apparatus according to an embodiment of the present invention (Part 2);

FIG. 11 is a schematic diagram showing an example of a hardware configuration of a data processing apparatus according to an embodiment of the present invention;

FIG. 12 is a schematic diagram showing a configuration of the main functions (main function parts) for realizing a data obtaining function according to an embodiment of the present invention;

FIG. 13 is a schematic diagram showing components included in the main function parts for realizing a data obtaining function according to an embodiment of the present invention;

FIG. 14 is a table showing an example of a relationship between a view and an attribute of data obtained by a view according to an embodiment of the present invention;

FIG. 15 is a schematic diagram showing a relationship between view identifying data (request data) and a view according to an embodiment of the present invention;

FIG. 16 is an example of a table stored with view generation programs according to an embodiment of the present invention;

FIG. 17 is a schematic diagram for describing expansion of an address list view by plug-in according to an embodiment of the present invention;

FIG. 18 shows an example of an operation conducted when registering a view generation program according to an embodiment of the present invention;

FIG. 19 is a sequence diagram showing an example of an operation conducted when generating a view according to an embodiment of the present invention;

FIG. 20 is a sequence diagram showing an example of an operation conducted when generating a full view according to an embodiment of the present invention;

FIG. 21 is a schematic diagram showing a function configuration in view of generalizing a data obtaining function (framework establishment of data obtaining function) according to an embodiment of the present invention;

FIG. 22 is a schematic diagram showing an example of an operation conducted when generating a view having a generalized data obtaining function according to an embodiment of the present invention; and

FIG. 23 is a schematic diagram showing an example of collectively obtaining data from plural types of data according to an embodiment of the present invention.

### DETAILED DESCRIPTION OF THE PREFERRED EMBODIMENTS

### First Embodiment

### Hardware Configuration of Image Processing Apparatus

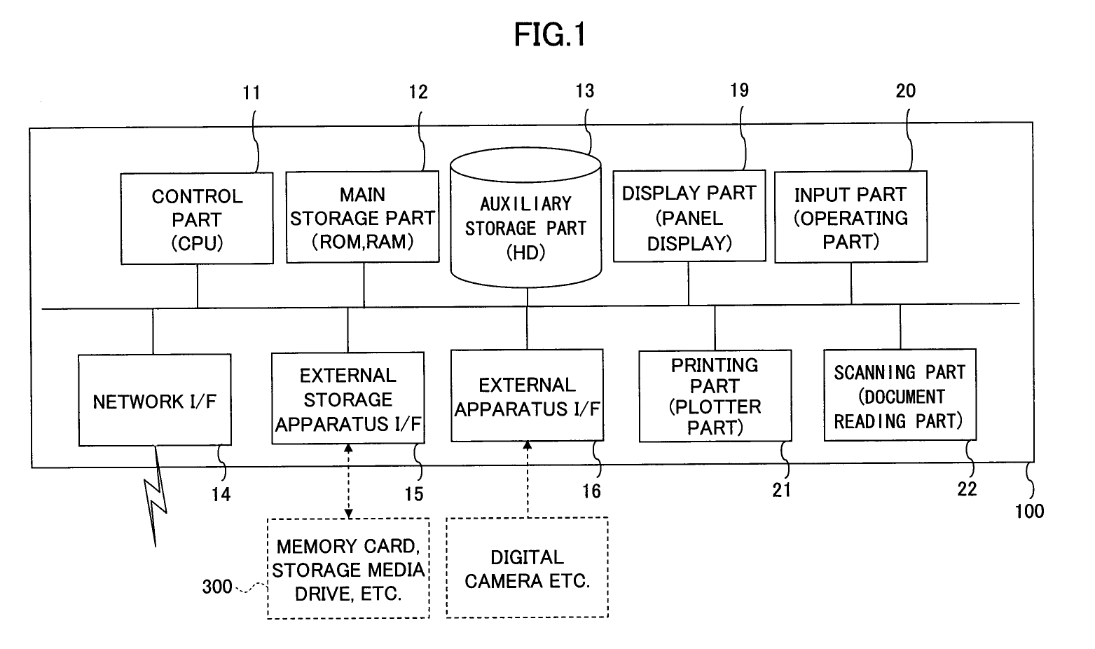

A hardware configuration of an image forming apparatus according to an embodiment of the present invention is described with reference to FIG. 1.

FIG. 1 is a schematic diagram showing an exemplary hardware configuration of an image processing apparatus 100 according to a first embodiment of the present invention.

As shown in FIG. 1, the image processing apparatus 100 includes, for example, a control part 11, a main storage part 12, an auxiliary storage part 13, a network I/F 14, an external storage apparatus I/F 15, an external apparatus I/F 16, a display part (panel display) 19, an input part (operating part) 20, a printing part (plotter part) 21, and a scanning part (document reading part) 22.

The control part (CPU: Central Processing Unit) 11 is for controlling each apparatus and conducting calculation/processing of data. More specifically, the control part 11 is a calculating apparatus for executing a program(s) stored in the main storage part 12. The calculating apparatus receives data from an input apparatus or a storage apparatus and calculates/processes the received data, and outputs the calculated/processed data to an output apparatus or the storage apparatus.

The main storage part (e.g., ROM: Read Only Memory, RAM: Random Access Memory) 12 is a storage apparatus for storing or temporarily storing programs and data. For example, the main storage part 12 stores OS (Operating System) used as basic software executed by the control part (CPU) and programs such as application software.

The auxiliary storage part (e.g., HD: Hard Disk) 13 is another storage apparatus for storing data related to the OS or the application software. The auxiliary storage part 13 includes various data managed by the image processing apparatus 100 such as user data. The various data are managed by, for example, a database (DB: database) function or a file system (FS: File System) function of the image processing apparatus 100.

The network I/F 14 is an interface between the image processing apparatus 100 and peripheral apparatuses (including peripheral apparatuses having a communications function) connected to the image processing apparatus 100 via a network comprising wired and/or wireless data transmission path such as LAN (Local Area Network) and WAN (Wide Area Network).

The external storage apparatus I/F 15 is an interface between the image processing apparatus 100 and an external storage apparatus (e.g., storage media drive) connected to the image processing apparatus 100 via a data transmission path (e.g., USB (Universal Serial Bus).

The external apparatus I/F 16 is an interface between the image processing apparatus 100 and an external input apparatus (e.g., digital camera) connected to the image processing apparatus 100 via a data transmission path (e.g., USB).

The image processing apparatus 100 exchange various data with external apparatuses via the interfaces 15, 16 (e.g., transmitting/receiving of data, reading/writing of data).

The display part (panel display) 19 and the input part (operating part) 20 include a LCD (Liquid Crystal Display) having, for example, a key switch (hard key) and a soft key having a touch panel function (GUI (Graphical User Interface). The display part 19 and the input part 20 serve as a UI (User Interface) when using the functions of the image processing apparatus 100.

The printing part (plotter part) 21 is a plotter apparatus for outputting (printing) image data to a transfer paper (printing paper) upon receiving image data comprising CMYK (Cyan, Magenta, Yellow, Black) by using an electrophotographic process (including an exposing step, a latent image forming step, a developing step, and a transferring step) with a laser beam.

The scanning part (document reading part) 22 is a reading apparatus for generating digital image data of 8 bit RGB data by scanning a document placed on a document reading plane (contact glass), that is, reading data from a paper medium and converting the read data into digital data. The reading apparatus includes, for example, a line processor having CCD (Charge Coupled Devices) photoelectric conversion elements, an A/D converter, and a driving circuit for driving the photoelectric conversion elements and the A/D converter.

Accordingly, in the image processing apparatus 100, the control part (CPU) 11 executes the programs stored in the storage apparatuses (main storage part 12, auxiliary storage part 13) and transmits control signals (control commands) to each apparatus (i.e. controls each apparatus), to thereby achieve the functions of the image processing apparatus 100 (e.g., copying function, facsimile function, scanner function, printer function). Thus, the data managed in the image processing apparatus 100 or the data managed in the system (network) connected to the image processing apparatus 100 can be suitably processed.

### <Problems of Conventional Art>

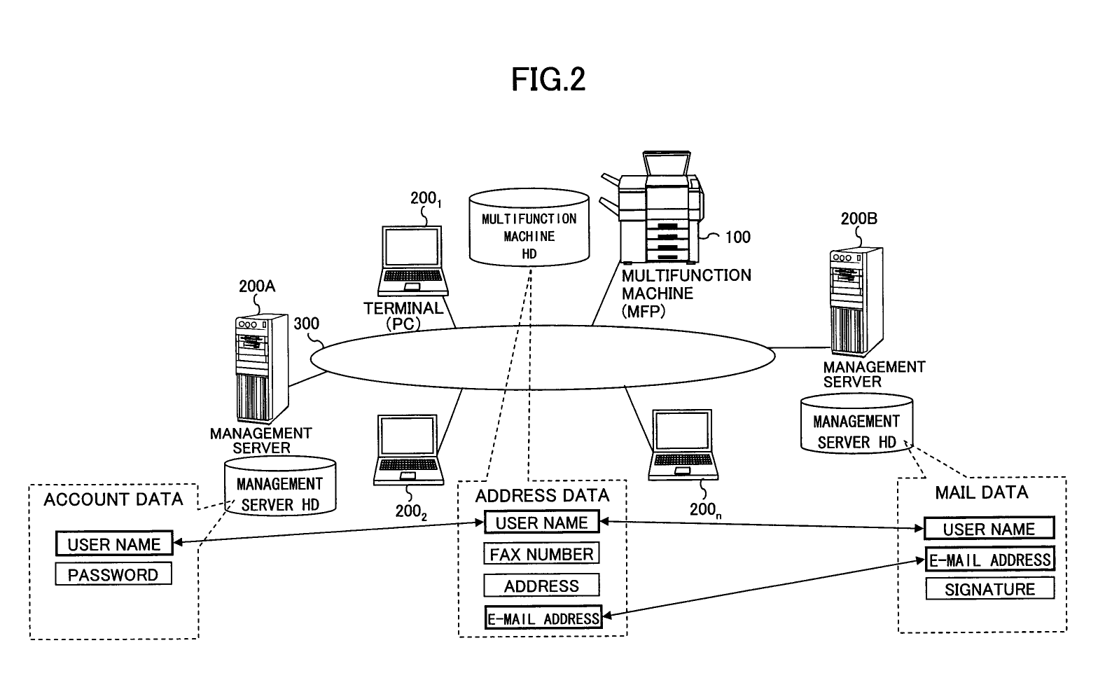

The problems of a conventional art are described with reference to FIG. 2. FIG. 2 is a schematic diagram showing a system to which the image processing apparatus (multifunction machine) 100 according to an embodiment of the present invention is connected.

The system shown in FIG. 2 includes plural data processing apparatuses 200n including the image processing apparatus (multifunction machine) 100, a management server 200A, a management server 200B, and one or more terminals (PC) of the user 200₁-200ₙ that are connected to a network 300 (e.g., LAN, WAN) comprising wired and/or wireless data transmission paths. The image processing apparatus 100 includes a storage apparatus (e.g., HD) containing address data stored in correspondence with each user. The address data includes attributes such as “user name”, “fax number”, “address”, and “e-mail address”. Accordingly, the image processing apparatus 100 manages the address data in correspondence with each user. Furthermore, the management server 200A also has a storage apparatus (e.g., HD) containing account data stored in correspondence with each user. The account data includes attributes such as “user name” and “password”. Accordingly, the management server 200A manages the account data in correspondence with each user. The management server 200B also has a storage apparatus (e.g., HD) containing mail data stored in correspondence with each user. The mail data includes attributes such as “user name”, “e-mail address” and “signature”. Accordingly, the management server 200B manages the mail data in correspondence with each user.

As shown in the system illustrated in FIG. 2, user data, for example, are managed and operated at plural locations (e.g., image processing apparatus 100, management server 200A, management server 200B) in the system depending on the purpose of the data. For example, “user name”, which identifies the user, is included in the attributes of “address data”, “account data”, and “mail data”. Furthermore, “e-mail address”, which indicates the e-mail address of the user” is included in the attributes of “address data” and “mail data”. Accordingly, data having the same content are redundantly managed and operated at plural locations in the system. Thus, with this system, in a case where there is a change in the configuration of the user data (e.g., addition/change of “user name” or “e-mail address”), the address data, the account data, and the mail data which all include the attributes have to be changed at the same time.

Accordingly, in managing/manipulating data in a system based on the purpose of the data, it is extremely difficult to manage the conformity of data having the same attributes. This is particularly difficult since the data included in the user data are frequently changed also since the process of changing the data is complicated.

With this system, unless a data obtaining function (e.g., UI) included in the image processing apparatus 100, the management server 200A, the management server 200B, or the user PC (terminal) 200n does not keep track of the configuration of the data (data source) containing the target data (data to be obtained), the data obtaining function (e.g., UI) is unable to obtain data according to the request of the user (including an application used in each apparatus in the system). It is to be noted that the term “user” not only includes the actual user but may also include an application acting to perform various operations for the user. In other words, changes in the configuration of the data source affect the data obtaining function included in the image processing apparatus 100, the management server 200A, the management server 200B, and the user PC (terminal) 200n.

In view of this problem, the below-described embodiments of the present invention enable integrative management/operation of data managed in the system and allow the user (including an application used in each apparatus in the system) to easily obtain the data managed in the system.

### <Data Obtaining Function According to Embodiment of Present Invention>

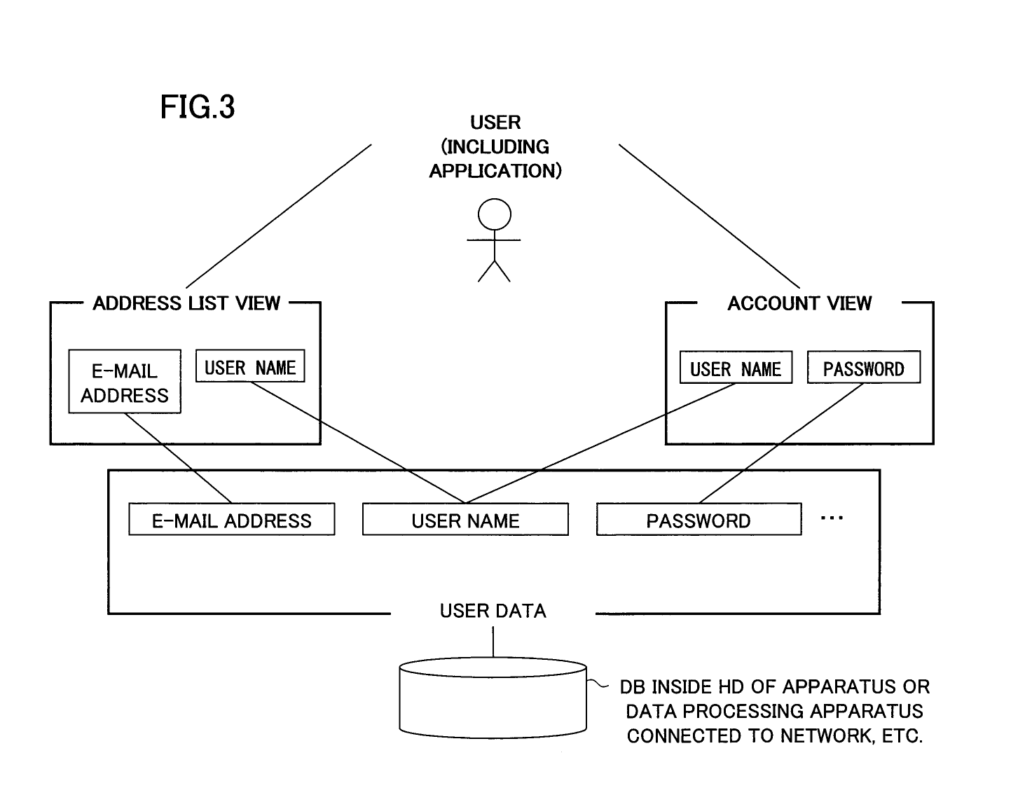

The data obtaining function according to an embodiment of the present invention is described with reference to FIGS. 3, 4, and 5.

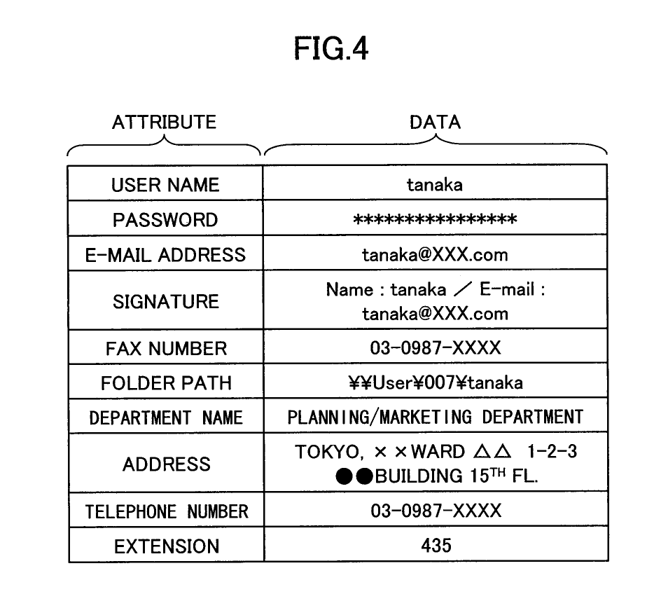

FIG. 3 is a schematic diagram for describing one aspect (Part 1) of the data obtaining function according to an embodiment of the present invention. FIG. 4 shows an example of a data configuration of user data according to an embodiment of the present invention.

As shown in FIG. 3, an embodiment of the present invention includes a “view” used for obtaining necessary data from the data managed in the system according to a request from the user (including an application used in each apparatus in the system). It is to be noted that “view” is a program for obtaining necessary data from a data source based on the attribute of data.

For example, various attributes (e.g., “e-mail address”, “user name”, “password”) are included in the user data, as shown in FIG. 4. In a case where the user desires to use address data, the user can obtain necessary data such as a “user name” and an “e-mail address” from the user data via a view referred to as an “address list view”. In another case where the user desires to use account data, the user can obtain necessary data such as a “user name” and a “password” from the user data via a view referred to as an “account view”.

Since the view is simply a program for obtaining data, the view does not need to store the data inside itself. For example, in a case where the view (program) is executed by a user desiring to use address data, since the view (program) keeps track of the attributes necessary for the address data (e.g., “user name”, “e-mail address”), the view can obtain data (e.g., “tanaka” “tanaka@XXX.com) corresponding to the attributes necessary for the address data from a data source (user data).

By using the data obtaining function according to an embodiment of the present invention, the user can designate (i.e. pass as a parameter) a set of desired data (e.g., “address data”, “account data”) to the view and obtain the set of desired data by activating (i.e. instructing activation) the view. That is, the user can precisely obtain desired data without having to understand the configuration of the set of desired data (e.g., “address data”, “account data”). Furthermore, even if there is a change in the configuration of the set of desired data (addition, change, or deletion of attributes), the change does not affect the data obtaining function.

It is to be noted that the data configuration of the user data illustrated in FIG. 4 is merely an example for describing the data obtaining function according to an embodiment of the present invention. Thus, the attributes and the data corresponding to the attributes do not have to be configured in a table format as shown in FIG. 4. That is, as long as the attributes and the data of the user data are configured to satisfy a one on one relationship, the data of the user data may be, for example, stored in an auxiliary storage apparatus (HD) in a format where the data are stored in a record in correspondence with the attributes.

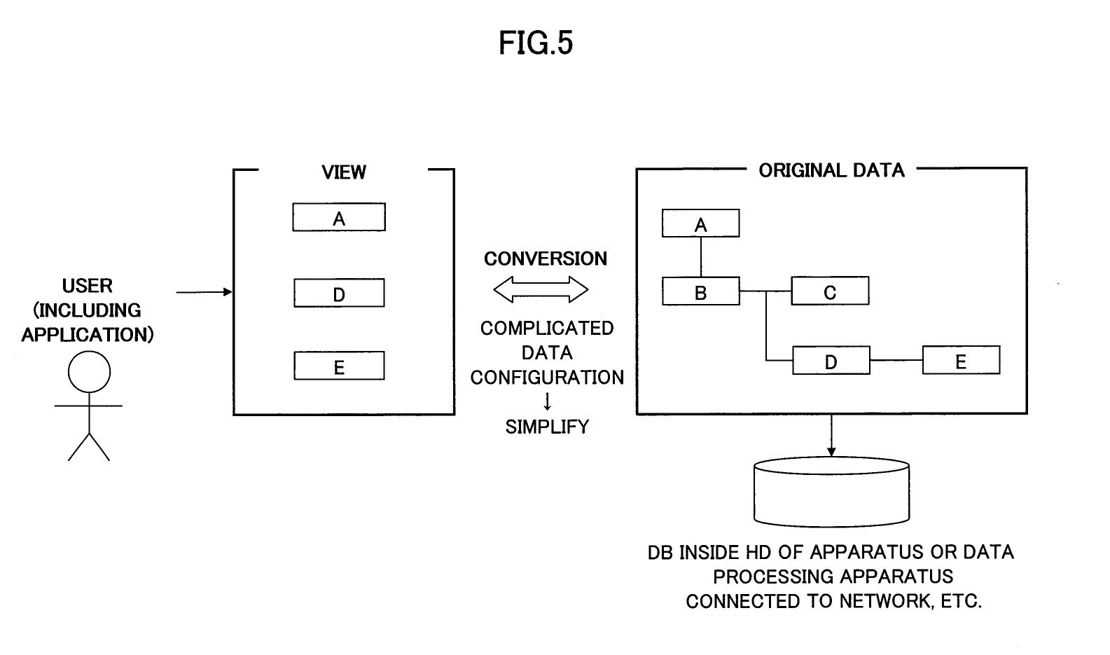

FIG. 5 is a schematic diagram for describing for describing another aspect (Part 2) of the data obtaining function according to an embodiment of the present invention.

The data managed in the system are not limited to the user data illustrated in FIG. 4, but also include, for example, document data and device data (apparatus data). Some of the data managed in the system may have a complicated configuration such as a layered structure. In a conventional example, it is necessary to understand the configuration of the data including the desired data in order for the user to obtain desired data in the system.

However, by using a view according to an embodiment of the present invention, the user can obtain desired data even from data (group of data) having a complicated configuration. That is, the view can convert (simplify) the data having a complicated configuration to a configuration enabling the user to easily obtain the data.

Thus, by using the data obtaining function according to an embodiment of the present invention, the user can precisely obtain desired data without understanding the configuration of the group of data containing the desired data, as described in FIG. 3. Furthermore, even if there is a change in the configuration of the group of desired data (addition, change, or deletion of attributes), the change does not affect the data obtaining function.

### <Exemplary Operation of Application Using Data Obtained by View>

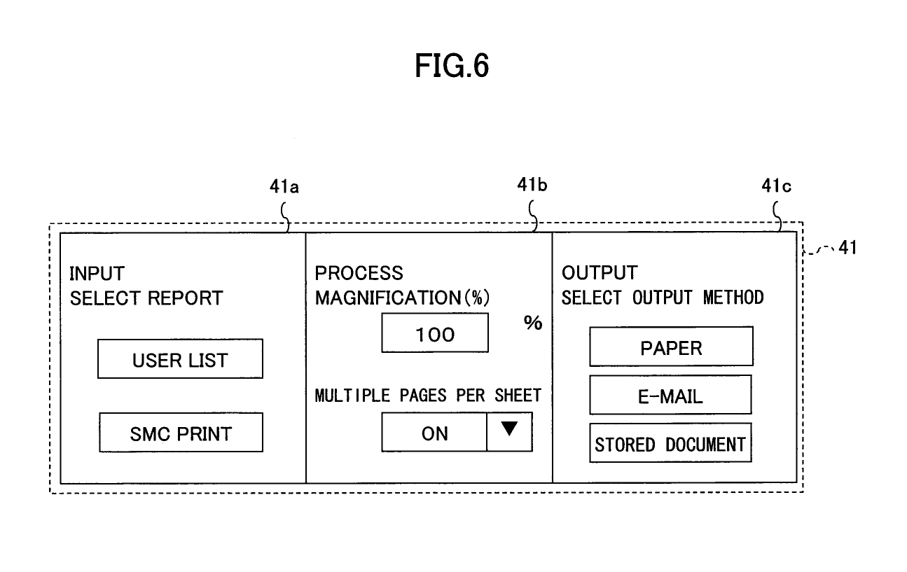

Next, an exemplary operation of an application using data obtained by a view is described with reference to FIG. 6. The application includes a function of outputting a report containing data managed by an apparatus according to an embodiment of the present invention. This application (function) is included in the image processing apparatus 100 according to an embodiment of the present invention.

FIG. 6 shows an example of a user interface (UI) user for setting the controls for conducting a combination of steps of performed when outputting the report (report outputting operation) according to an embodiment of the present invention. In this example, the combination of steps includes data input, data process, and data output.

In conducting the report outputting operation, a user interface (UI) 41 as shown in FIG. 6 is displayed on a display part 19 included in the image processing apparatus 100 according to an embodiment of the present invention. With the image processing apparatus 100 according to an embodiment of the present invention, the user can set (designate) the details (specifics) of the report outputting operation for each step (data inputting step, data processing step, data outputting step) performed in the report outputting operation via the user interface 41. For example, in a case of setting a group of data desired to be input, the user can select the content of the report such as “user data” or “SMC data” displayed on a report content selection screen 41a. Furthermore, the user can select the method for processing the report such as “magnification” and “multiple pages per sheet” displayed on an output mode selection screen 41b. Furthermore, the user can select the method for outputting the report such as “printing”, “e-mail”, or “stored document” displayed on an output method selection screen 41c.

In a case where “user data” or “SMC data” is selected as the data desired to be input (input data) via the report content selection screen 41a of the user interface (UI) 41, the report outputting function (application) obtains the selected input data from the data which are managed inside the system. For example, when “user data” is selected, the report outputting function (application) obtains necessary data via a user data view. The user data view serves to obtain data necessary for outputting a user report. Then, the report outputting function (application) performs the steps of processing/outputting on the data obtained by the user data view, to thereby output a user report.

By using the data obtaining function, among the data managed inside the system, the data required for enabling the image processing apparatus 100 to execute a function desired by the user (e.g., user data in a case where the desired function is a report outputting function) can be easily and accurately input to the application that executes the desired function.

### <Software Configuration and Basic Steps (Operations) of Image Processing Apparatus 100>

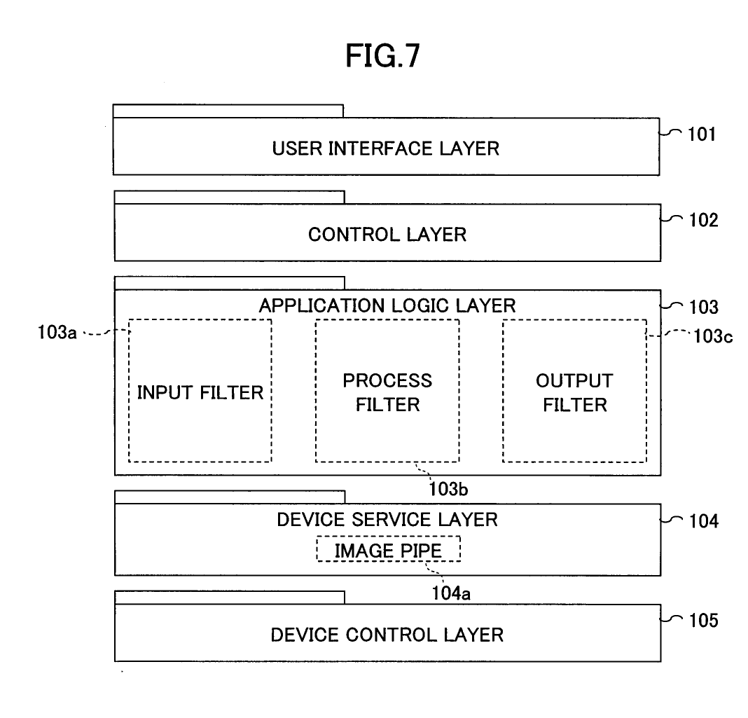

The software configuration and basic steps (operations) of the image processing apparatus 100 are described with reference to FIGS. 7-10 in a case of realizing a function(s) of the image processing apparatus 100 by using the data obtained by the view as described in the example of the report outputting function (application) shown in FIG. 6. It is to be noted that the image processing apparatus 100 may be configured to include the below-described data processing apparatus 200 according to an embodiment of the present invention.

FIG. 7 is a schematic diagram showing an example of a software configuration of the image processing apparatus according to an embodiment of the present invention.

As shown in FIG. 7, the software includes, for example, a user interface layer 101, a control layer 102, an application logic layer 103, a device service layer 104, and a device control layer 105. In terms of the relationship (hierarchy) among the layers illustrated in FIG. 7, a layer positioned at a higher level basically calls for a layer positioned at a lower level.

The user interface layer 101 is a part installed with a function for receiving a request for execution of a function (e.g., an application function such as a copier function, a facsimile function, a scanner function, a printer function). The user interface layer 101 includes, for example, a local user interface (UI) which receives requests from the user via a communication server part for receiving requests transmitted through the network from a user PC 200n, the display part 19, and the input part 20. The request received by the user interface layer 101 is sent to the control layer 102.

The control layer 102 is a part installed with a function for controlling the process(es) for executing the requested function. More specifically, the control layer 102 connects each filter in the application logic layer 103 according to the requested function and controls the execution of the request function based on the connected filters. It is to be noted that the function of the image processing apparatus 100 according to an embodiment of the present invention has substantially the same meaning as a single combined unit (group) of services (starting from a process of inputting a request to a final process of outputting desired data). From the aspect of software, the function of the image processing apparatus 100 according to an embodiment of the present invention has substantially the same meaning as an application which provides a single combined unit (group) of services.

The application logic layer 103 is a part installed with a group of components for realizing a part of the function provided by the image processing apparatus 100. That is, by combining the components of the application logic layer 103, a single function can be realized. In this embodiment of the present invention, these components are referred to as “filters”. In this case, the software architecture of the image processing apparatus 100 is based on a concept referred to as a “pipe & filter”.

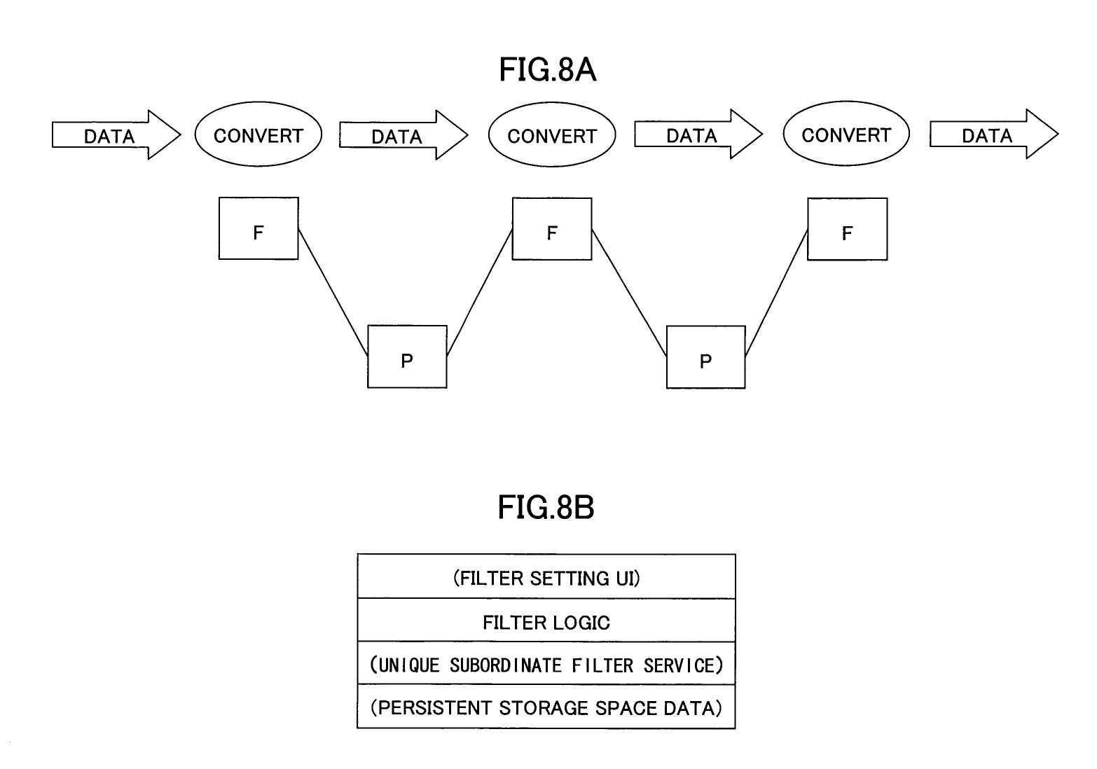

FIG. 8A is a schematic diagram for describing the concept of “pipe & filter”, and FIG. 8B is a schematic diagram for describing an example of the elements which constitute a filter.

In FIG. 8A, “F” indicates a “filter” and “P” indicates a “pipe”. As shown in FIG. 8A, each filter is connected to a pipe. The filter performs “conversion” on input data and outputs the “converted” data. The pipe transmits the data output from the filter to the next filter. That is, in the image processing apparatus 100 according to an embodiment of the present invention, each function is regarded as a series of “conversions” performed on data (e.g., user data, document data) managed inside the image processing apparatus 100. Thus, each function of the image processing apparatus 100 can be generalized as a set of steps (operations) including an inputting step, a processing step, and an outputting step which are performed on the data managed inside the image processing apparatus 100. Accordingly, the “inputting” step, the “processing” step, and the “outputting” step are regarded to constitute a “conversion” step. Accordingly, the filter is a software component for realizing a single “conversion” step. The filter for realizing the inputting step is referred to as an input filter. The filter for realizing the processing step is referred to as a process filter. The filter for realizing the outputting step is referred to as an output filter. It is to be noted that the filters are independent from each. There is basically no dependency among the filters (i.e. a relationship where a filter is called by another filter). Therefore, addition (installing) or deletion (uninstalling) of the filters can be conducted in units of a single filter.

Returning to FIG. 7, the input filter 103a may include: a reading filter for controlling an operation of reading (scanning) image data with the scanner part 22 and outputting the read image data; a stored document readout filter for reading out document data (image data) stored in the auxiliary storage part 13 and outputting the read out image; a mail receiving filter for receiving electronic mail and outputting the data contained in the received electronic mail; a facsimile receiving filter for controlling an operation of receiving faxed data and outputting the received data, a PC document receiving filter for receiving printout data from user PCs 200 and outputting the received printout data; and a report filter for modifying data (e.g., setting data or history data in the image processing apparatus 100) into a predetermined format (e.g., table format) and outputting the modified data.

The process filter 103b may include: a document processing filter for performing a predetermined image process (e.g., multiple pages per sheet, magnification, reduction) on input data and outputting the processed data; and a document converting filter for converting input PostScript data into bitmap data and outputting the converted data (rendering process).

The output filter 103c may include: a printing filter for outputting input data to the printing part 21; a stored document registering (recording) filter for storing input data to the auxiliary storage part 13; a mail transmitting filter for attaching input data to electronic mail and transmitting the electronic mail; a facsimile transmitting filter for transmitting input data by facsimile (i.e. faxing input data); a PC document transmitting filter for transmitting input data to a user PC 200n of the user (as shown in FIG. 2); and a preview filter for displaying input data as a preview image on the display part 19.

The device service layer 104 is a part installed with a function (subordinate function) commonly used (shared) by each filter in the application logic layer 103. The device service layer 104 may include: an image pipe 104a for transmitting data output from one filter to the next filter; and a data managing part having various databases (e.g., a database (DB) in which user data are registered, a database (DB) in which document data or image data are stored).

The device control layer is a part installed with a group of program modules (referred to as “drivers”) for controlling various devices (hardware). The device control layer may include a scanner control part, a plotter control part, a memory control part, a telephone line control part, and a network control part. Each of the control parts controls a device corresponding to their names.

FIG. 8B is a schematic diagram showing an example of elements included in a filter. As shown in FIG. 8B, each filter includes, for example, a filter setting UI, a filter logic, a unique subordinate filter service, and persistent storage space data. It is to be noted that the filter setting user interface (UI), depending on the filter, the unique subordinate filter service, and the persistent storage space data may not necessarily be included as the elements constituting the filter.

The filter setting UI is a program for displaying, for example, a screen used in setting the conditions for executing a filter on the display part 19. For example, in a case of the reading filter, a screen for setting the resolution, density, type of image may be displayed be the filter setting UI. In a case where display by the display part 19 is performed based on HTML (HyperText Markup Language) data or a script, the filter setting UI may preferably be HTML data or a script.

The filter logic is a program installed with logic used in realizing a function of a filter. That is, the filter logic uses, for example, the unique filter subordinate service included as an element of the filter, the device service layer 104, or the device control layer 105, to thereby realize a function of a filter according to the execution conditions set by the user via the filter setting UI. For example, in a case of the reading filter, the filter logic may be logic for controlling an operation of reading a document with the scanner part 22.

The unique subordinate filter service is a subordinate function (library) necessary for realizing the filter logic. That is, in a case of a function corresponding to the device service layer 104 or the device control layer 105 but is only used by a single filter, such function may be installed as a part dedicated to the filter, that is, installed as a unique subordinate filter service. The unique subordinate filter service may not always be required to be installed in a filter. For example, in a case of a reading filter for providing a function of controlling the scanner part 22, the function may be installed as a scanner control part in the device control layer 105 and not in the reading filter.

The persistent storage space data include, for example, schema definitions of data required to be stored in a non-volatile memory. For example, the data may include data to be set to the filter (e.g., default parameters of the conditions for executing the filter). The schema definitions are registered (recorded) in the data managing part during the installation of the filter.

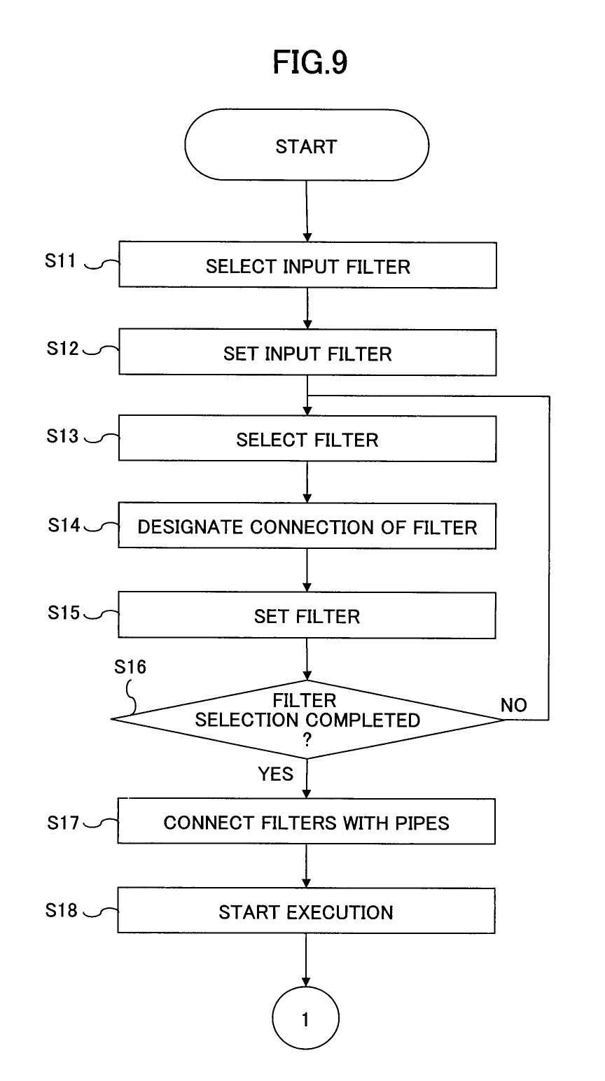

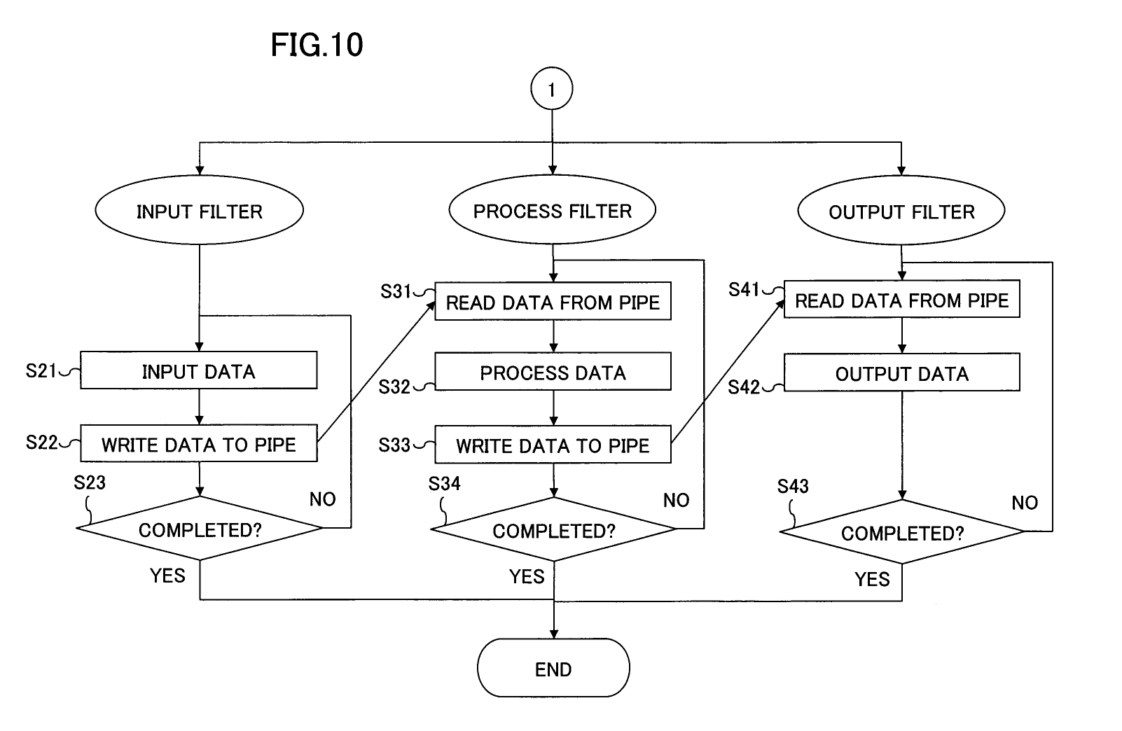

Next, the basic steps (operations) of the software configuration of the image processing apparatus 100 according to an embodiment of the present invention are described with reference to FIGS. 9 and 10.

FIGS. 9 and 10 are flowcharts showing the basic steps (operations) of the software configuration of the image processing apparatus 100 according to an embodiment of the present invention. In this example, the basic steps are the steps conducted for realizing a single function of the image processing apparatus 100 according to an embodiment of the present invention.

First, an input filter is selected by a user (Step S11). Then, the conditions for executing the selected input filter are set (Step S11). Likewise, the process filter or the output filter is selected (Step S13). Then, the connection between the selected filters is designated (Step S14) and the execution conditions of the filter are set (Step S15).

The foregoing steps may be conducted via the user interface (UI) 41 shown in FIG. 6 based on the control of the local user interface of the user interface layer 101. The exemplarily illustrated display of FIG. 6 shows a request inputting screen including selection areas corresponding to “data input 41a”, “data processing 41b”, and “data output 41c”. The data input area 41a is for selecting an input filter. The data processing area 41b is for selecting a process filter. The data output area 41c is for selecting an output filter. Each selection area 41a-41c is provided with one or more key switches (including software keys) corresponding to the selectable filters. For the sake of convenience, FIG. 6 shows the key switches corresponding to the report input filters (e.g., “user list”, “SMC print”) in the data input area 41a, the key switches corresponding to the report processing filters (e.g., “magnification”, “multiple pages per sheet”) in the data processing area 41b, and the key switches corresponding to the report output filters (e.g., paper (printout), e-mail, stored document) in the data output area 41c. It is to be noted that plural input filters 103a, process filters 103b, and output filters 103c may be selected with respect to one function. For example, in a case of printing data onto paper and also transmitting data by e-mail during a report outputting operation, at least two output filters 103c (printout filter, e-mail filter) are selected.

Returning to the flowchart of FIG. 9, when selection of filters is completed (Yes in Step S16), the requested contents (e.g., type of filters, conditions set to the filters) are reported from the user interface layer 101 to the control layer 102 upon depression of a start button.

The control layer 102, upon receiving the requested contents from the user interface layer 101, connects the selected filters with pipes (Step S17). Although the actual entity of the pipe is a memory (including auxiliary storage part (HD) 13), the type of memory to be used differs depending on the filters on both ends of the pipe. The relationship between the pipes and the filters are, for example, defined beforehand in the auxiliary storage part 13 of the image processing apparatus 100. Based on the defined relationship, the control layer 102 connects the filters with specific pipes. Then, the control layer 102 outputs execution requests (requests for execution) to each of the filters in parallel (Step S18). That is, the calls (requests) to each of the filters are not conducted according to the order in which the filters are connected but rather substantially at the same time. In other words, each filter, upon receiving an execution request from the control layer 102, waits for data to be input from a pipe connected to its input side. It is, however, to be noted that there is no pipe on the input side of the input filter 103a. Therefore, the input filter 103a initiates an inputting operation upon receiving an execution request from the control layer 102.

In FIG. 10, the input filter 103a inputs data with an inputting device (Step S21). The input data is output (written) to a pipe connected to the output side of the input filter 103a (Step S22). In a case where data are dividedly input in a plural number of times (e.g., a case of scanning plural documents), the step of inputting data and the step of outputting (writing) the input data to the pipe are repeated. After the steps of inputting data and outputting the input data to the pipes are completed (Yes in Step S23), the input operation of the input filter 103a is completed.

The process filter 103b, upon detecting input of data from a pipe connected to its input side, initiates a process operation. First, the process filter 103b reads the data from the pipe connected to its input side (Step S31). Then, the process filter 103b performs an image process on the read data (Step S32). Then, the process filter 103b outputs (writes) the processed data to a pipe connected to its output side (Step S33). Then, after all of the data input from the pipe connected to the input side of the process filter 103b have been processed (Yes in Step S34), the processing operation of the process filter 103b is completed.

The output filter 103c, upon detecting input of data from a pipe connected to its input side, initiates an output operation. First, the output filter 103c reads data from the pipe connected to its input side (Step S41). Then, the output filter 103c outputs the read data by using an outputting device (Step S42). Then, after all of the data input from the pipe connected to the input side of the output filter 103b have been output (Yes in Step S43), the output operation of the output filter 103c is completed.

<Data Obtaining Function with Pipe & Filter>

Next, based on the foregoing description of the software configuration and the basic steps using the pipe & filter concept, the data obtaining function according to an embodiment of the present invention is described.

In order to realize the application (e.g., report outputting function shown in FIG. 6) installed in the software configuration using the pipe & filter concept, first, a series of steps (workflow) including an inputting operation, a processing operation, and an outputting operation is to be configured by combining the input filter 103a (data inputting part) for inputting data, the process filter 103b (data processing part) for processing input data, and the output filter 103c (data outputting part) for outputting the processed data. Then, each of the filters (data inputting part, data processing part, data outputting part) are to be connected by pipes.

Thereby, the application can realize a series of steps (workflow), that is, a function of the application by transmitting the data input at the input filter (data inputting part) 103a to the process filter (data processing part) 103b of the subsequent step and transmitting the data processed at the process filter (data processing part) 103b to the output filter (data outputting part) 103c.

Accordingly, the view obtains necessary data from the data managed in the system in accordance with the execution instruction from the input filter (data inputting part) 103a of the application and provides the obtained data to the application. Thereby, the data obtaining function based on the pipe & filter concept can be realized. In a case where the user requests to browse (access) necessary data via the display part 16, the view obtains the requested necessary data from the data managed in the system in accordance with the execution instruction from an application for realizing a user interface (41) function and provides the obtained data to the user (application).

Hence, the data obtaining function according to an embodiment of the present invention can be installed as a function commonly used by each application.

### <Hardware Configuration of Data Processing Apparatus>

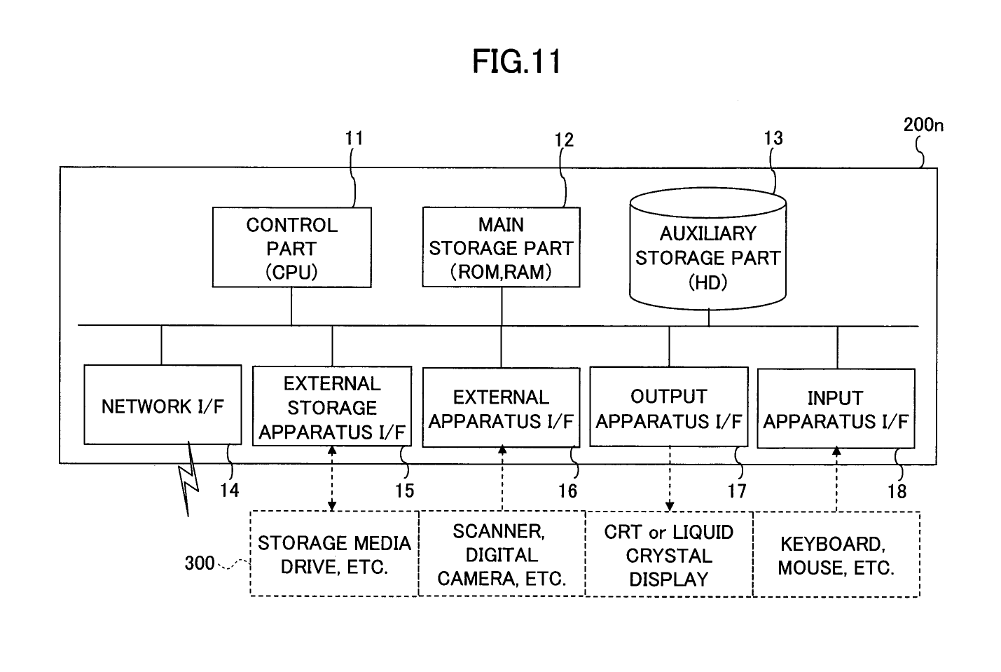

FIG. 11 is a schematic diagram showing a hardware configuration of a data processing apparatus 200n according to an embodiment of the present invention.

As shown in FIG. 11, the data processing apparatus 200n includes a control part 11, a main storage part 12, an auxiliary storage part 12, a network I/F 14, an external storage apparatus I/F 15, an external apparatus I/F 16, an output apparatus I/F 17, and an input apparatus I/F 18. Since these elements (parts) of the data processing apparatus 200n have substantially the same functions as corresponding elements (parts) shown in the above-described image processing apparatus 100, like elements (parts) are denoted with like reference numerals as shown in FIG. 1 and are not described in further detail. Thus, different elements (parts) are mainly described below.

The output apparatus I/F 17 is an interface between an output apparatus (e.g., CRT (Cathode Ray Tube), LCD (Liquid Crystal Display)) and the data processing apparatus 200n which are connected by a data transmission path (e.g., dedicated cable).

The input apparatus I/F 18 is an interface between an input apparatus (e.g., keyboard, mouse) and the data processing apparatus 200n which are connected by a data transmission path (e.g., USB).

Accordingly, in the data processing apparatus 200n, the control part (CPU) executes a program stored in a storage apparatus (e.g., main storage part 12, auxiliary storage part 13) and sends control signals (control commands) to each apparatus (i.e. controls each apparatus), to thereby realize a function(s) of the data processing apparatus 200n. The difference with respect to the image processing apparatus 100 is that the characteristics of the input/output apparatuses connected to the data processing apparatus are different. The data processing apparatus 200n and the image processing apparatus 100 are substantially the same in terms of the fact that the data managed in the data processing apparatus 200n or the data managed in the system connected to the data processing apparatus 200n are processed by having the control part (CPU) execute a program and control each apparatus. Therefore, the minimal elements of hardware for achieving an object of “providing integrative management/operation of data managed in a data processing apparatus or data managed in a system connected to the data processing apparatus and enabling the user (including an application operating in each apparatus in the system) to easily obtain the data managed in the data processing apparatus or the data managed in the system connected to the data processing apparatus” are substantially the same for both the image processing apparatus 100 and the data processing apparatus 200n. Accordingly, the embodiment of the data processing apparatus 200n described below is explained on the premise that the above-described image processing apparatus 100 includes the function of the data processing apparatus 200n.

### <Configuration of Main Functions (Main Function Parts)>

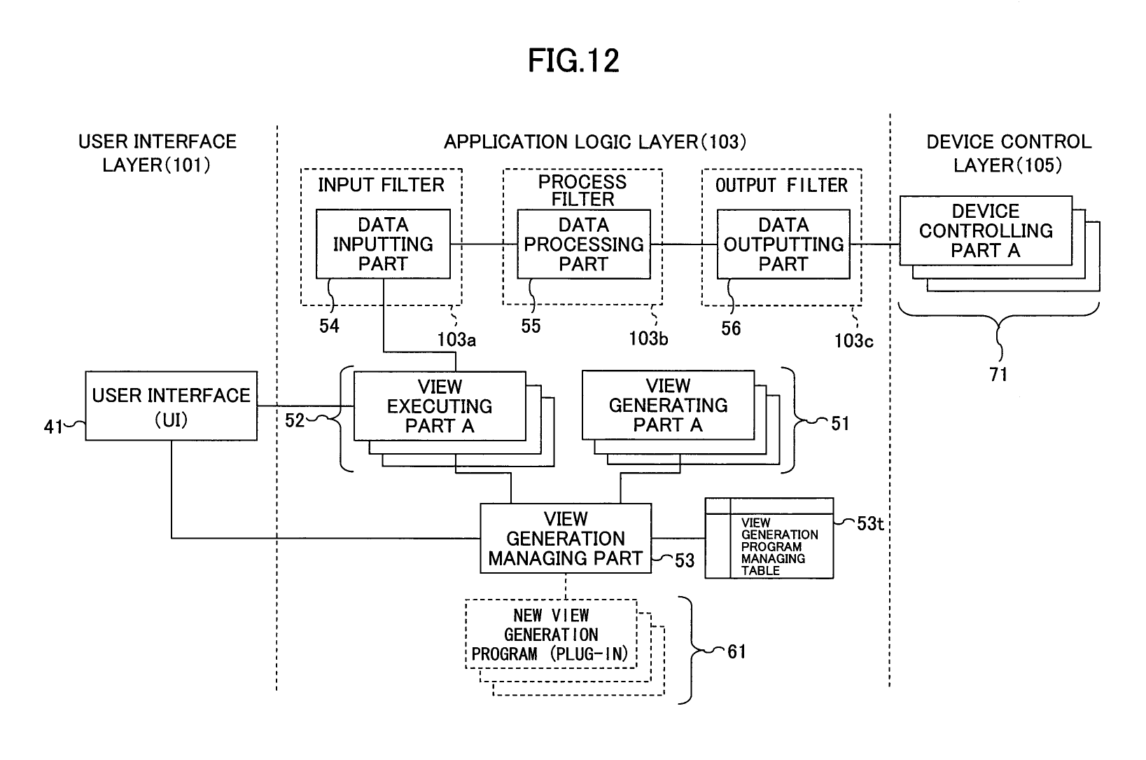

Next, a configuration of the main functions (main function parts) and elements (components) included in the main functions (main function parts) for realizing the data obtaining function according to an embodiment of the present invention is described with reference to FIGS. 12-17.

FIG. 12 is a schematic diagram showing a configuration of the main functions (main function parts) for realizing the data obtaining function according to an embodiment of the present invention.

As shown in FIG. 12, the main function parts include, for example, a view generating part 51, a view executing part 52, a view generation managing part 53, a data inputting part 54, a data processing part 55, and a data outputting part 56. Among the main function parts according to an embodiment of the present invention, the data inputting part 54 corresponds to the input filter 103a, the data processing part 55 corresponds to the process filter 103b, and the data outputting part 56 corresponds to the output filter 103c.

The view generating part 51 includes a function of generating a view which is a program for obtaining data necessary to be input to the data inputting part 54 for realizing a series of steps (workflow) of a function of the data processing apparatus 200n. The necessary data are obtained from the data managed in the data processing apparatus 200n or the data managed in a system (network) connected to the data processing apparatus 200n in accordance with a request from the user. The function of the view generating part 51 is initiated when a program for generating a view (view generation program) is activated, that is, when the program is loaded to the main storage part 12 (e.g., RAM).

The view executing part 52 includes a function of executing the view generated by the view generating part 51 in accordance with an execution instruction from a user (application). Thus, the view executing part 52 executes the view in accordance with an execution instruction from the data inputting part 54 or the user interface (UI) 41 and transmits the data obtained by executing the view.

The view generation managing part 53 includes a function of managing the view generation program by using a view generation program managing table 53t indicative of one or more view generation programs listed in correspondence with view identifying data (e.g., view names). The details of the view generation program managing table 53t are explained in the below-description for a view generation managing part 83 included in the view generation managing part 53. The user interface (UI) 41 receives a request for executing an application (execution request) from the user and transmits view identifying data (e.g., view name) corresponding to the received execution request to the view generation managing part 53. The view identifying data include data for requesting obtainment of data necessary for realizing a function (a series of steps including an input step, a process step, and an output step (workflow)) of the data processing apparatus 200n. The view generation managing part 53 obtains a corresponding view generation program from the view generation program managing table 53t based on the view identifying data and activates the obtained view generation program.

Furthermore, the view generation managing part 53 also includes a function of registering a new view generation program 61 to the view generation program managing table 53t and a function of deleting a registered view generation program from the view generation program managing table 53t.

The data inputting part 54, which corresponds to the input filter 103a of an application, includes a function of inputting data necessary for realizing a function (a series of steps including an input step, a process step, and an output step (workflow)) of the data processing apparatus 200n according to a request from a user. Accordingly, the data inputting part 54 inputs data obtained by a view.

The data processing part 55, which corresponds to the process filter 103b of an application, includes a function of processing data input from the data inputting part 54 with a processing method based on a request from the user.

The data outputting part 56, which corresponds to the output filter 103c of an application, includes a function of outputting the data processed by the data processing part 55 in a format (mode) requested by the user. In order to output the processed data in a format requested by the user, the data outputting part 56 selects a suitable outputting device. That is, the data outputting part 56 selects a suitable device controlling part 71. For example, in a case where the user request the processed data to be output in the form of electronic mail, the data outputting part 56 selects a network controlling part.

With the above-described configuration of the data processing apparatus 200n according to an embodiment of the present invention, integrative management/operation of data managed in a data processing apparatus or data managed in a system connected to the data processing apparatus can be achieved and the user (including an application operating in each apparatus in the system) can easily obtain the data managed in the data processing apparatus or the data managed in the system connected to the data processing apparatus.

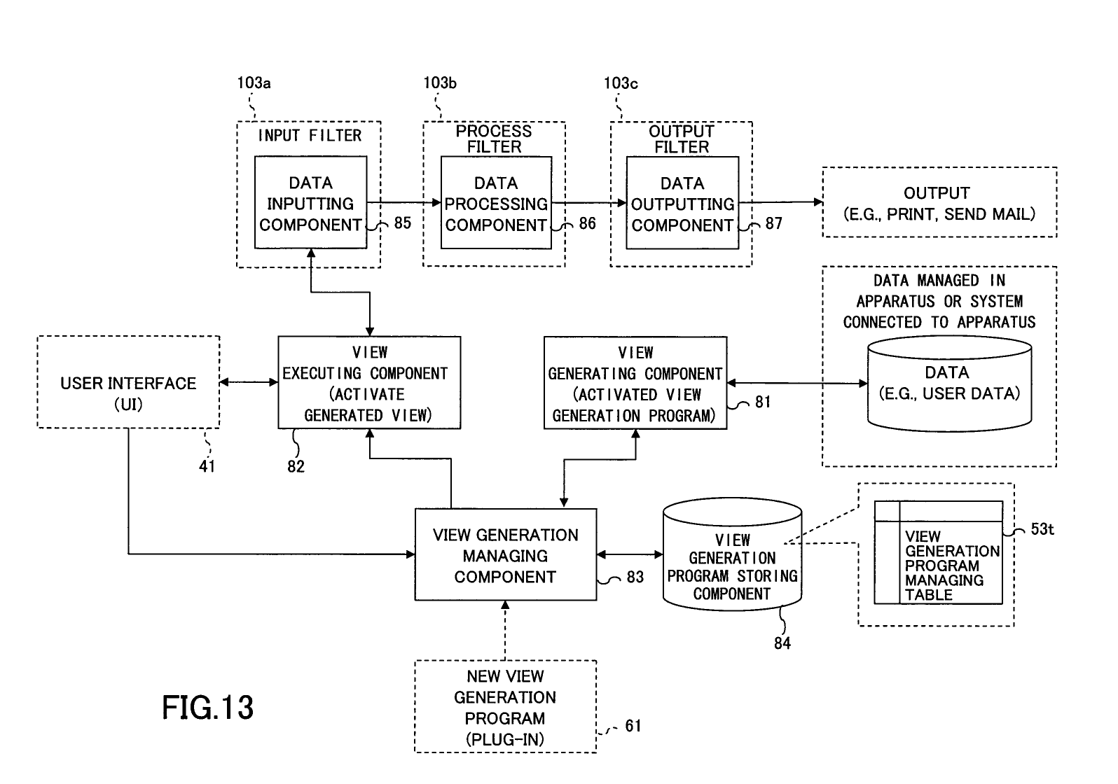

FIG. 13 is a schematic diagram showing components included in the main function parts for realizing the data obtaining function according to an embodiment of the present invention.

As shown in FIG. 13, the components of the main function parts include, for example, a view generating component 81, a view executing component 82, a view generation managing component 83, a view generating program storing component 84, a data inputting component 85, a data processing component 86, and a data outputting component 87.

The view generating component 81 is included in the view generating part 51. The view generating component 81 is generating a view which is a program for obtaining data necessary to be input to the data inputting part 54 for realizing a series of steps (workflow) of a function of the data processing apparatus 200n. The necessary data are obtained from the data managed in the data processing apparatus 200n or the data managed in a system (network) connected to the data processing apparatus 200n in accordance with a request from the user. The function of the view generating component 81 is initiated by the activation of the view generation program (i.e. loading the view generation program to the main storage part 12 (e.g., RAM)). After the view generation program is activated, the view generating component 81 obtains attributes of the data to be obtained by a view from the data managed in the data processing apparatus 200n or the data managed in a system connected to the data processing apparatus 200n based on predetermined data concerning the attributes and adds the obtained attributes to a view, to thereby generate a view (program) for obtaining data. For example, the method for generating a view with the view generating component 81 may be performed by preparing a template including a program code (program code independent from data to be obtained) that can be commonly used for realizing a data obtaining function and adding the attributes of the data to be obtained to the template.

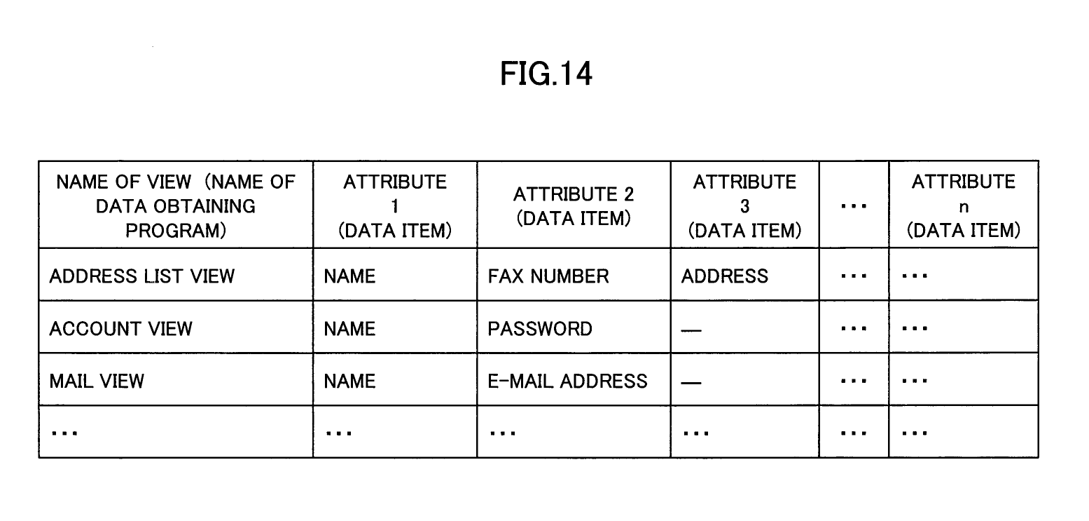

Next, a relationship between a view and an attribute of the data obtained by the view is described with reference to FIG. 14.

FIG. 14 is a table showing an example of the relationship between a view and an attribute of the data obtained by the view according to an embodiment of the present invention.

The attribute(s) obtained by the view generating component 81 differs depending on the data to be obtained by a generated view (i.e. data to be input to the data inputting component 85 according to a request by a user). As shown in FIG. 14, in a case of generating an address list view for obtaining “address data”, the view generating component 81 obtains attributes such as “user name”, “fax number”, and “address” from the user data shown in FIG. 4. Furthermore, in a case of generating a mail view for obtaining “mail data”, the view generating component 81 obtains attributes such as “user name”, “e-mail address”, and “signature” from the user data shown in FIG. 4. Accordingly, the data of the attribute to be obtained may be stored in a program during the stage of developing the view generation program (coding stage) or stored as external data in an external apparatus, so that the external data can be read when the view generation program is activated.

Since the attributes of the data to be obtained by the view are set beforehand, the view generating component 81 can obtain necessary attributes when the view generation program is activated. Therefore, the view generating component 81 can generate a view (program) for obtaining data to be input to the data inputting component 85 according to a request by the user.

Returning to FIG. 13, the view executing component 82 is included in the view executing part 52. The view executing component 82 is for executing the view generated by the view generating component 81 in accordance with an execution instruction from a user (application). The view executing component 82 executes a view in accordance with an execution instruction from the user inputting component 85 or the user interface (UI) 41 and transmits the data obtained by executing the view. Based on the attributes added by the view generating component 81 during the view generating operation, the view obtains data corresponding to the attributes from the data managed in the data processing apparatus 200n or the data managed in a system connected to the data processing apparatus 200n. For example, in a case of a view for obtaining address data, the view obtains data (e.g., “tanaka”, “03-0987-X XXX”) corresponding to the attributes (e.g., “user name”, “fax number”) added to the view during the view generating operation.

Accordingly, in accordance with a request from the user, the view executing component 82 can obtain data required to be input to the data inputting component 85 from the data managed in the data processing apparatus 200n or the data managed in the system connected to the system.

With the data processing apparatus 200n according to an embodiment of the present invention, since the user obtains data with the view, data can be provided to the user without obtaining unnecessary data or affecting the configuration of the data.

The view generation managing component 83 is included in the view generation managing part 53. The view generation managing component 83 is for managing one or more view generation programs by using the view generation program managing table 53t indicative of one or more view generation programs listed in correspondence with view identifying data (e.g., view names).

The user interface (UI) 41 receives a request for executing an application (execution request) from the user and transmits view identifying data (e.g., view name) corresponding to the received execution request to the view generation managing part 53. The view identifying data include data for requesting obtainment of data necessary for realizing a function (a series of steps including an input step, a process step, and an output step (workflow)) of the data processing apparatus 200n.

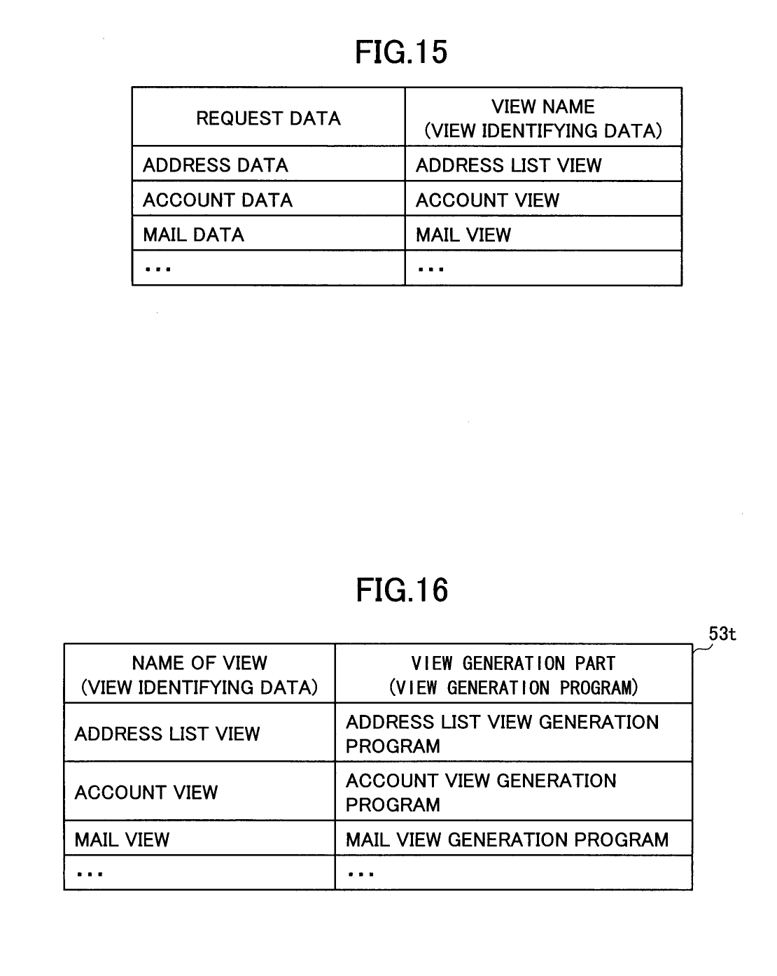

Next, a relationship between view identifying data (request data) and a view according to an embodiment of the present invention is described with reference to FIG. 15.

The request data (execution request) transmitted from the user interface (UI) 41 to the view generation managing component 83 indicate data for identifying a view (view identifying data) for obtaining a set of desired data necessary for realizing a function (series of steps including an input step, a process step, and an output step (workflow)) of the data processing apparatus 200n requested by the user. For example, with reference to FIG. 14, in a case where the user requests the report outputting function of the data processing apparatus 200n to output an address list (user list), view identifying data having a view name “address list view” are transmitted from the user interface (UI) to the view generation managing component 83. In this case, the view identifying data “address list view” serves to identify the view for obtaining “address data” (i.e. data necessary for outputting the address list (user list)). In another example, in a case where the user requests the report outputting function of the data processing apparatus 200n to output a mail address list, view identifying data having a view name “mail view” are transmitted from the user interface (UI) to the view generation managing component 83. In this case, the view identifying data “mail view” serves to identify the view for obtaining “mail data” (i.e. data necessary for outputting the mail address list).

Next, the view generation program managing table 53t according to an embodiment of the present invention is described with reference to FIG. 16.

FIG. 16 is an example of a table stored with view generation programs (view generation program managing table 53t) according to an embodiment of the present invention.

The view generation program managing table 53t has view identifying data listed in correspondence with view generation programs. As shown in FIG. 16, in a case where the view identifying data (view name) is “address list view”, “address list view generating program” is identified as a corresponding view. In a case where the view identifying data (view name) is “mail view”, “mail view generating program” is identified as a corresponding view. It is, however, to be noted that the manner in which the view identifying data and the corresponding view generation programs are stored is not limited to a table format of the view generation program managing table 53t. The view identifying data and the view generation programs may be stored in other formats as long as the view identifying data and the view generation programs are stored to satisfy a one on one relationship. Thus, the view generation program managing table 53t is one example of a view generation program storing component 84.

Returning to FIG. 13, the view generation managing component 83 manages view generation programs, for example, by additionally registering (storing) a new view generation program (view generation program for generating a view for obtaining new data) 61 in the view generation program storing component 84 (e.g., view generation program managing table 53t) or deleting a registered view generation program stored in the view generation program storing component 84 (e.g., view generation program managing table 53t). In a case where the view generation managing component 83 additionally registers or deletes a view generation program, view identifying data corresponding to the view generation program is also to be registered or deleted at the same time. The timing for additionally registering a new view generation program in the view generation program storing component 84 may be the time of installing the new view generation program or the time of activating the new view generation program. The timing for deleting a registered view generation program from the view generation storing component 84 may be the time of uninstalling the registered view generation program or the time of terminating (ending) the registered view generation program.

The view generation managing component 83, upon receiving view identifying data, searches for view identifying data that matches the received view identifying data in the view generation program storing component 84 (e.g., view generation program managing table 53t). In a case where the matching view identifying data is found, the view generation program corresponding to the view identifying data is obtained from the view generation program storing component 84 and activated (i.e. loaded to the main storage part 12 (e.g., RAM)). As a result, the view generation managing component 83 receives a view generated by the activation of the view generation program (view generating component 81) and transmits the received view to the data inputting part 85 of the application or the user interface (UI) 41.

Hence, the view generation managing part 83 can manage view generation programs stored in correspondence with view identifying data in the view generation program storing part 84, obtain a corresponding view generation program based on view identifying data (e.g., view name) indicated in request data requested by the user for obtaining a set of desired data necessary for realizing a function (series of steps including an input step, a process step, and an output step (workflow)) of the data processing apparatus 200n, and activate the obtained view generation program.

Thereby, the data processing apparatus 200n according to an embodiment of the present invention can easily and flexibly respond to changes in the configuration of the data managed in the data processing apparatus 200n or the data managed in a system connected to the data processing apparatus 200n. For example, the data processing apparatus 200n according to an embodiment of the present invention can easily and flexibly respond to addition, change, or deletion of an attribute in a case of adding new data or changing registered data. Furthermore, the data managed in the data processing apparatus 200n or the data managed in a system connected to the data processing apparatus 200n can be managed/operated in an integrated manner.

Returning to FIG. 13, the data inputting component 85 is included in the data inputting part 54. The data inputting component 85 inputs data necessary for realizing a function (a series of steps including an input step, a process step, and an output step (workflow)) of the data processing apparatus 200n according to a request from a user. Furthermore, the data inputting component 85 instructs execution to the view executing component and activates the view generated by the view generating component 81. As a result, the data inputting component 85 can input data obtained by the view.

The data processing component 86 is included in the data processing part 55. The data processing component 86 processes data input from the data inputting component 85 with a processing method based on a request from the user.

The data outputting component 87 is included in the data outputting part 56. The data outputting component 87 outputs the data processed by the data processing component 86 in a format (mode) requested by the user. Thus, in accordance with the request from the user, the data outputting component 87 can output the processed data in the form of a printout or electronic mail.

With the above-described components of the main function parts included in the data processing apparatus 200n, integrative management/operation of data managed in the data processing apparatus 200n or data managed in a system connected to the data processing apparatus 200n can be achieved. In addition, the user can easily obtain data managed in the data processing apparatus 200n or data managed in a system connected to the data processing apparatus 200n.

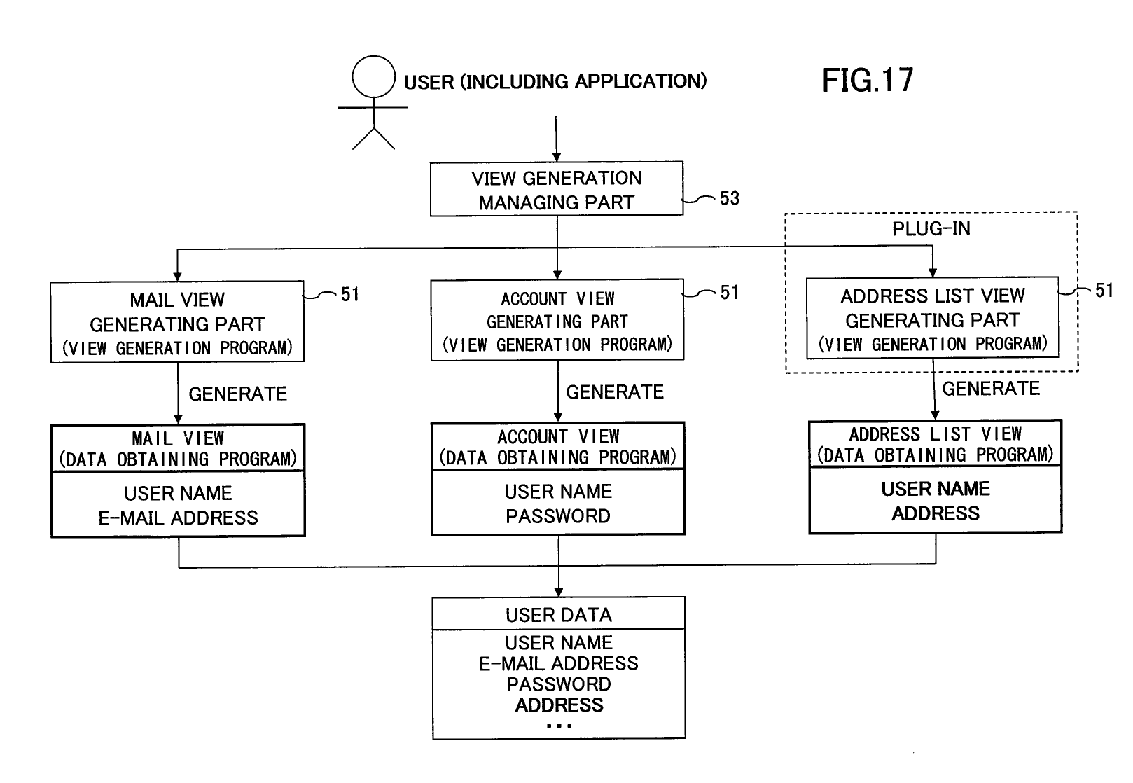

The components of the main function parts can be installed in a suitable layer (e.g., application logic layer 103) in the software configuration based on the pipe & filter concept shown in FIG. 17.

### <Expansion of Data Obtaining Function>

Next, a method of expanding the data obtaining function installed in the data processing apparatus 200n according to an embodiment of the present invention is described with reference to FIG. 17.

FIG. 17 is a schematic diagram for describing expansion of an address list view by plug-in according to an embodiment of the present invention.

Expansion of the data obtaining function can be realized by plugging in a new view generation program 61 as a new component for providing new data. With the new view generation program 61, new data can be obtained with a view generated with the new view generation program 61. In this example, “plug-in” refers to adding a new view generation program 61 as a function to an installed component. In the plug-in operation, the view generation managing part 53 registers the new view generation program 61 and view identifying data (e.g., view name) identifying the new view generation program 61 in the view generation program storing component 84 (e.g., view generation program managing table 53t).

With this method of installing a new view generation program, deletion of an unnecessary data obtaining function or addition of a new data obtaining function can be dynamically achieved (i.e. expansion of the data obtaining function can be dynamically achieved). Thus, in the above-described function configuration and installing method according to an embodiment of the present invention, data managed in the data processing apparatus 200n or data managed in a system connected to the data processing apparatus 200n can be obtained by preparing a view generating part (view generating program) 51 for generating a view that obtains data required to be input to a data inputting component 85 of an application in accordance with a request from the user and plugging in the view generating program to an installed report component as a new component having a new data obtaining function.

For example, with reference to FIG. 14, in a case of expanding a new data obtaining function for obtaining “address data” from user data, an address list view 82 for obtaining data corresponding to attributes such as “user name” or “address” from user data can be generated by preparing an address list view generating part (address list view generation program) 51 for obtaining “address data” and plugging in the address list view generation program to an installed component as a component having an address data obtaining function.

### <Operation of Each Component Included in Main Function Parts>

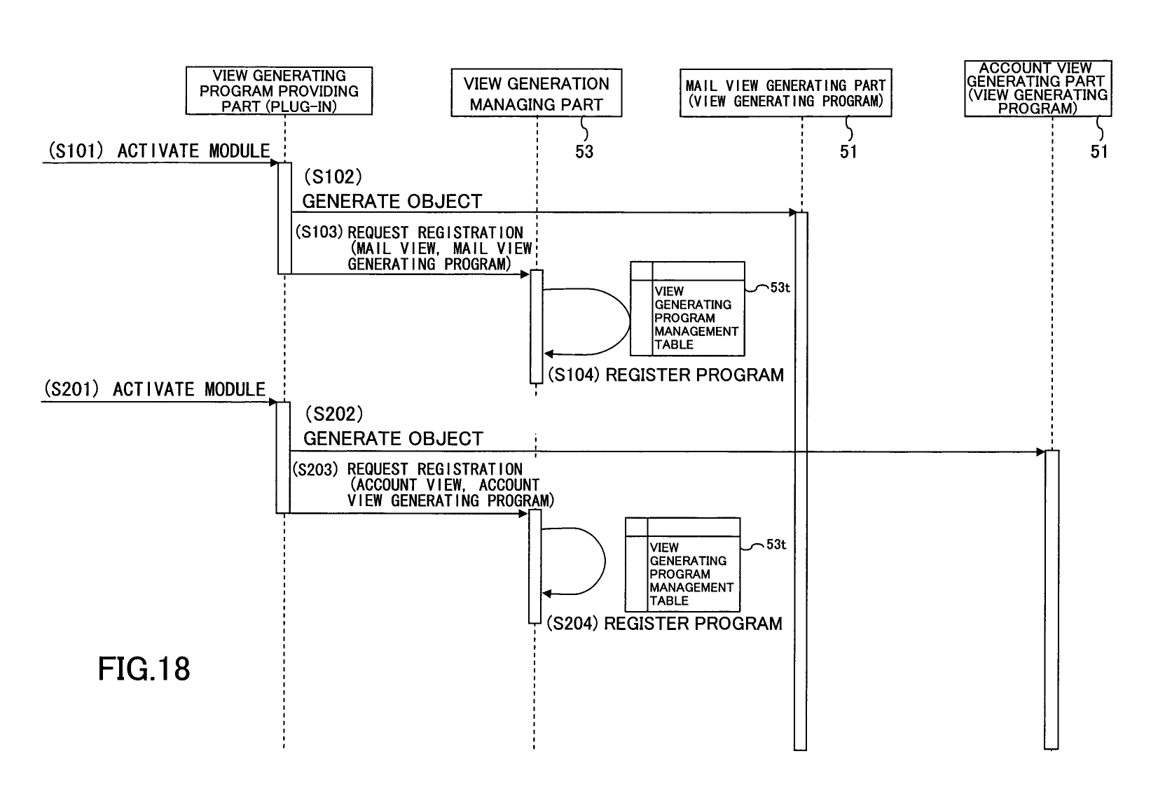

Next, operations of the above-described components included in the main function parts of the data processing apparatus 200n are described with reference to FIG. 18-20.

FIG. 18 shows an example of an operation conducted when registering a view generation program according to an embodiment of the present invention. More specifically, FIG. 18 shows an operation where the view generation managing part 53 registers a view generation program in the view generation program managing table 53t when a mail view generation program and an account view generation program are installed or activated.

First, in the data processing apparatus 200n, a plugged-in mail data obtaining function component receives an activation request (Step S101). Then, a view generation program providing part (plugged-in mail data obtaining function component) for providing a mail data obtaining function with a mail view generation program generates an object of the mail view generation program in the main storage part 12 (e.g., RAM) (Step S102).

Then, the view generation program providing part (plugged-in mail data obtaining function component) transmits a request for registering a new mail view generation program in the view generation program managing table 53t to the view generation managing part 53 along with parameters including data of the new mail view generation program and view identifying data for identifying the mail view generation program to be newly registered (Step S103).

As a result, the view generation managing part 53 uses the view generation managing component 83 to registers the received view identifying data and the data of the new mail view generation program in the view generation program managing table 53t and update the view generation program managing table 53t (Step S104).

Likewise, in the data processing apparatus 200n, a plugged-in account data obtaining function component receives an activation request (Step S201). Then, a view generation program providing part (plugged-in account data obtaining function component) for providing an account data obtaining function with an account view generation program generates an object of the account view generation program in the main storage part 12 (e.g., RAM) (Step S202).

Then, the view generation program providing part (plugged-in account data obtaining function component) transmits a request for registering a new account view generation program in the view generation program managing table 53t to the view generation managing part 53 along with parameters including data of the new account view generation program and view identifying data for identifying the account view generation program to be newly registered (Step S203).

As a result, the view generation managing part 53 uses the view generation managing component 83 to register the received view identifying data and the data of the new account view generation program in the view generation program managing table 53t and update the view generation program managing table 53t (Step S204).

The above-described data of the new view generation program (mail view generation program, account view generation program) include, for example, address values in the memory indicative of the object of the new view generation program generated in the main storage part 12 (e.g., RAM).

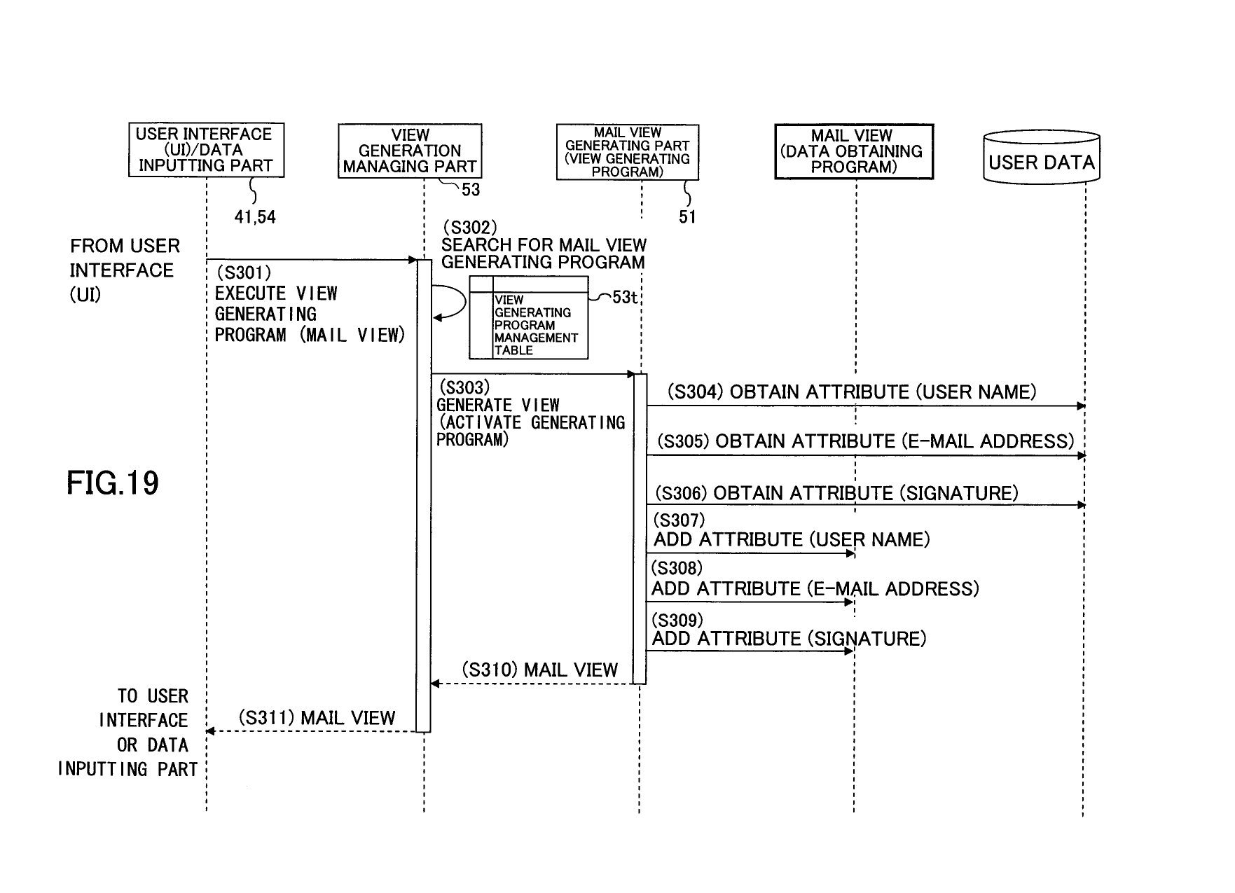

FIG. 19 is a sequence diagram showing an example of an operation conducted when generating a view according to an embodiment of the present invention. More specifically, FIG. 19 shows an operation where a mail view is generated.

In the data processing apparatus 200n, upon receiving view identifying data (e.g., view name), the view identifying data is transmitted to the view generation managing part 53 for requesting execution of the view generation program corresponding to the view identifying data (execution request) (S301).

The view generation managing part 53 uses the view generation managing component 83 to search for a view generation program (in this example, a mail view generation program) corresponding to the received view identifying data in the view generation program managing table 53t (Step S302). In a case where the mail view generation program is registered, the view generation managing part 53 requests the view generating part 51 to activate the mail view generation program. In other words, the view generation managing part 53 requests the mail view generating part 51 to generate a mail view (Step S303).

Then, based on the activated mail view generation program, the mail view generating part 51 uses the mail view generating component 81 to obtain attributes (e.g., user name, e-mail address, signature) of mail data from the user data managed in the data processing apparatus 200n or the data managed in a system connected to the data processing apparatus 200n (Step S304-S306). Although Steps S304-S306 of FIG. 19 show an operation where three attributes of the mail data (user name, e-mail address, signature) are obtained, all of the attributes necessary for obtaining mail data can be obtained.

Then, the mail generating part 51 uses the mail view generating component 81 to add the obtained attributes to a template of a mail view including program codes (program codes independent from data to be obtained) used for realizing a mail data obtaining function (Step S307-S309). The template of the mail view is prepared beforehand. Although Steps S307-S309 of FIG. 19 show addition of three attributes of the mail data (user name, e-mail address, signature), all of the obtained attributes of the mail data can be added. Although FIG. 19 shows the process of obtaining an attribute (Steps S304-S306) and the process of adding an attribute (Steps S307-S309) performed on the three attributes at a single time, the process of obtaining an attribute and the process of adding an attribute may be repeatedly performed one attribute at a time.

The mail view generating part 51 transmits the mail view generated by the mail view generating component 81 to the data inputting part 51 of an application or the user interface (UI) 41 via the view generation managing part 53 (Step S310-S311).

Then, the data inputting part 54 of an application or an application executing the user interface (UI) 41 requests the mail view executing part 52 to execute the mail view. Accordingly, the mail view executing part 52 activates the mail view (i.e. loads the mail view to the main storage part 12 (e.g., RAM) to thereby enable input of mail data obtained by the activated mail view.

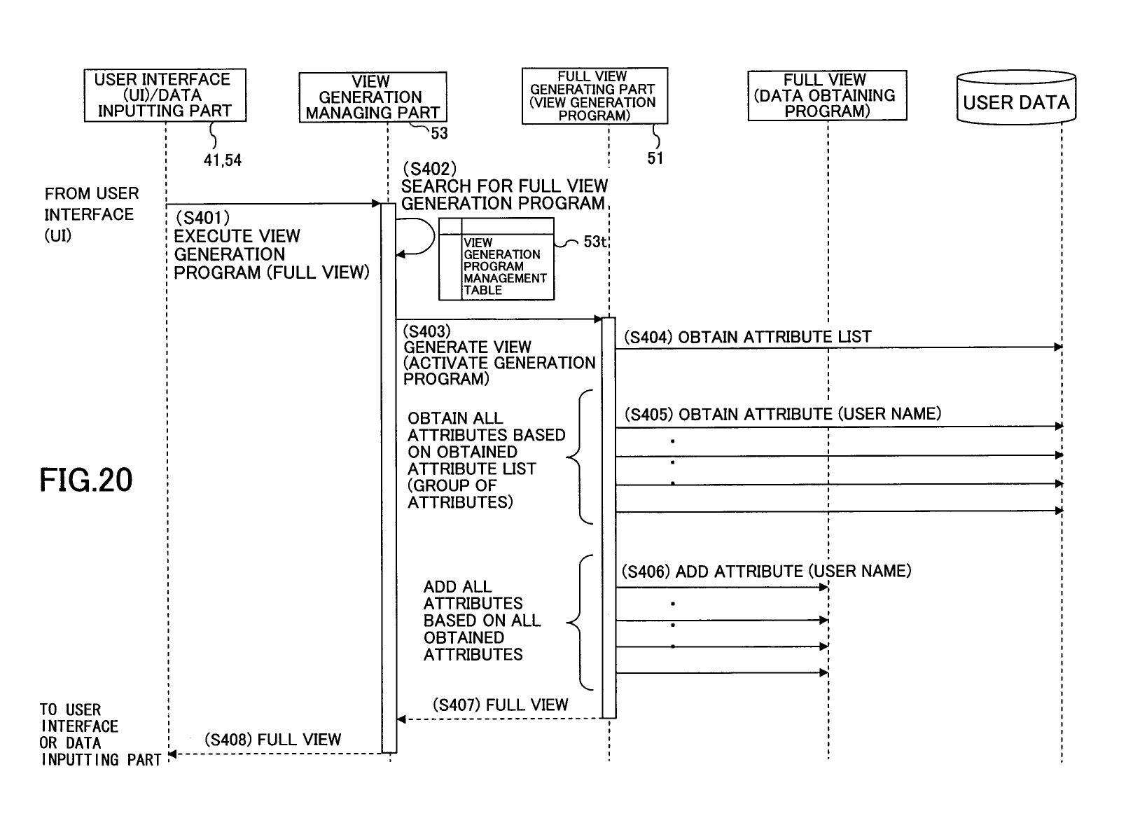

FIG. 20 is a sequence diagram showing an example of an operation conducted when generating a full view according to an embodiment of the present invention. In this example, a “full view” is a view for obtaining all of the data corresponding to all of the attributes of a predetermined data from data managed in a data processing apparatus 200n or data managed in a system connected to the data processing apparatus 200n. In general, it is difficult to understand (keep track) which attribute of a predetermined data (e.g., user data) is added, updated, or deleted, particularly in a case where the predetermined data (e.g., user data) is changed frequently. However, by using the full view, even where the user data are frequently changed, newest data can be precisely and easily obtained.

The main difference between the above-described view and the full view is the method in which the view generating part 51 obtains attributes of predetermined data from data managed in a data processing apparatus 200n or data managed in a system connected to the data processing apparatus 200n. The full view generated by the view generating part 51 obtains a group of attributes of predetermined data and obtains all of the data corresponding to the obtained group of attributes.

Next, an example of an operation conducted when generating a full view according to an embodiment of the present invention is described in detail.

In the data processing apparatus 200n, upon receiving view identifying data (e.g., view name), the view identifying data is transmitted to the view generation managing part 53 for requesting execution of the view generation program corresponding to the view identifying data (execution request) (S401).

The view generation managing part 53 uses the view generation managing component 83 to search for a view generation program (in this example, a full view generation program) corresponding to the received view identifying data in the view generation program managing table 53t (Step S402). In a case where the full view generation program is registered, the view generation managing part 53 requests the view generating part 51 to activate the full view generation program. In other words, the view generation managing part 53 requests the full view generating part 51 to generate a full view (Step S403).

Then, based on the activated full view generation program, the full view generating part 51 uses the full view generating component 81 to obtain an attribute list including a group of attributes (e.g., user name, e-mail address, signature) of the newest obtainable user data from the user data managed in the data processing apparatus 200n or the data managed in a system connected to the data processing apparatus 200n (Step S404). Then, all of the attributes in the user data are obtained based on the attribute list obtained by the full view generating component 81 (Step S405).

Then, the full view generating part 51 uses the full view generating component 81 to add all of the obtained attributes of the user data to a template of a full view including program codes (program codes independent from data to be obtained) used for realizing a user data obtaining function (Step S406). The template of the mail view is prepared beforehand. Although FIG. 20 shows the process of obtaining an attribute (Steps S405) and the process of adding an attribute (Steps S406) performed on the all necessary attributes at a single time, the process of obtaining an attribute and the process of adding an attribute may be repeatedly performed one attribute at a time.

The full view generating part 51 transmits the full view generated by the full view generating component 81 to the data inputting part 54 of an application or the user interface (UI) 41 via the view generation managing part 53 (Step S407-S408).

Then, the data inputting part 54 of an application or an application executing the user interface (UI) 41 requests the full view executing part 52 to execute the full view. Accordingly, the full view executing part 52 activates the full view (i.e. loads the full view to the main storage part 12 (e.g., RAM), to thereby enable input of full data obtained by the activated full view.

### <Generalizing (Framework Establishment) of Data Obtaining Function>

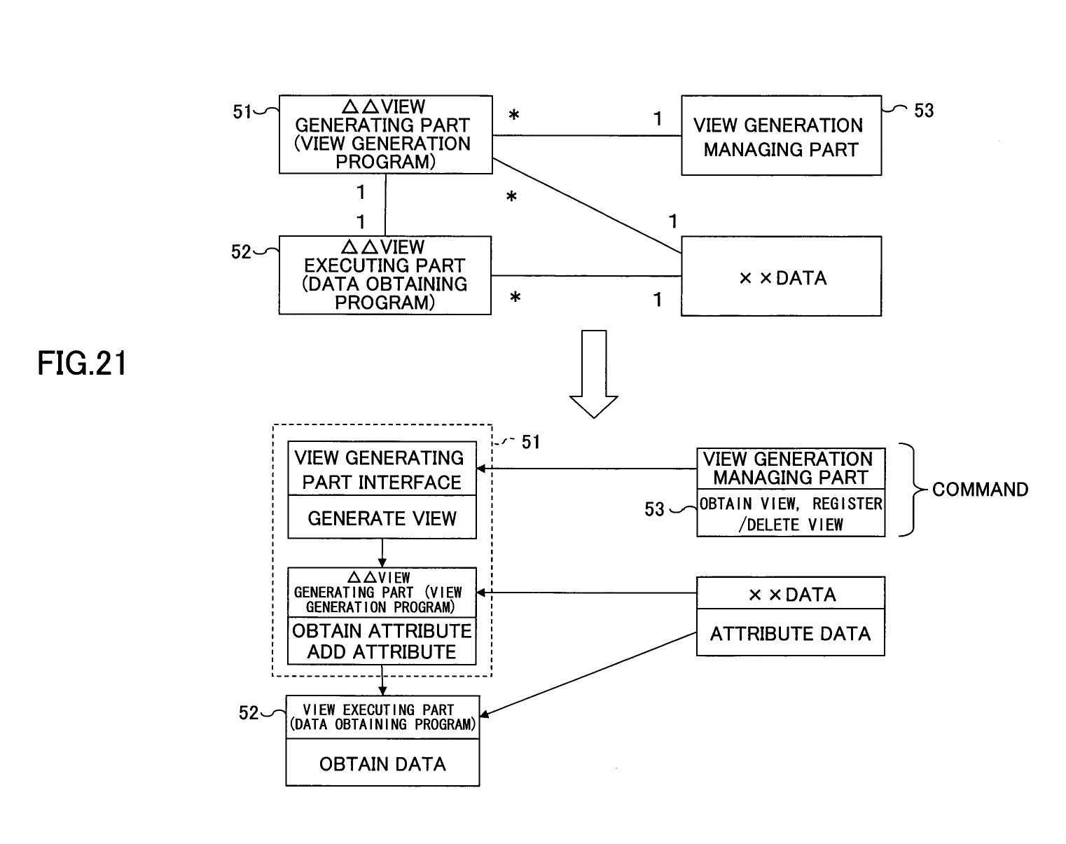

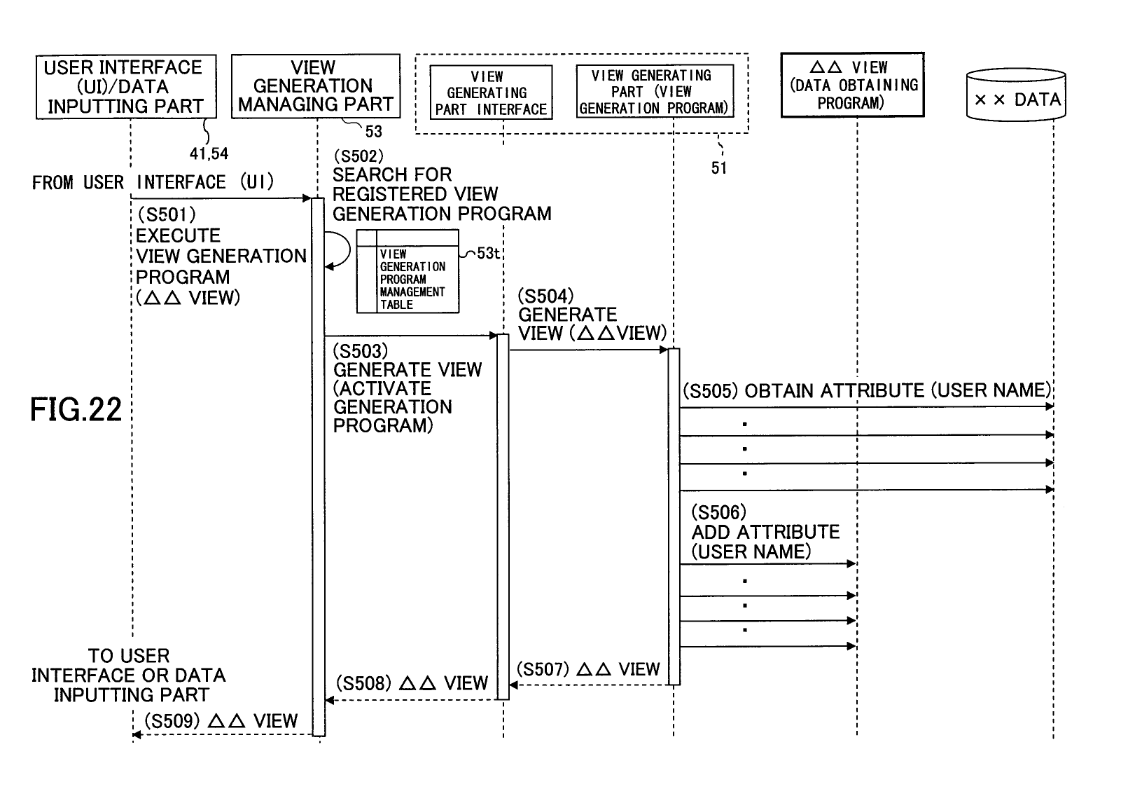

Next, establishment of the framework of the data obtaining function and the operation of the data obtaining function based on the framework are described with reference to FIGS. 21 and 22.

FIG. 21 is a schematic diagram showing a function configuration in view of generalizing the data obtaining function (framework establishment of data obtaining function) according to an embodiment of the present invention.

The basic configuration of the data obtaining function according to an embodiment of the present invention is basically the same with respect to data managed in a data processing apparatus 200n and data managed in a system connected to the data processing apparatus 200n. The basic configuration includes a view generating part 51 including a view generation program, a view executing part 52 for executing a program (data obtaining program) generated by the view generating part 51, a view generation managing part 53 for managing a view generation program, and data managed in a data processing apparatus 200n or data managed in a system connected to the data processing apparatus 200n (e.g., user data). The only part (function part) of the basic configuration which is dependent (subordinate) to data to be provided to the user (including an application operating in each apparatus in the system) is the view generating part 51 including the view generation program for generating a view for obtaining data (target data).

Thus, the basic configuration of the data obtaining function according to an embodiment of the present invention can be divided into a function part which is dependent (subordinate) to data to be provided to the user and a function part which can be generalized without depending on the data to be provided to the user.

As a result, the data obtaining function according to an embodiment of the present invention can be configured to a framework having a group of modules (including the view executing part 52 and the view generation managing part 53) which do not depend on the data to be provided to the user (target data). In this example, “framework” includes software functioning as a base application which provides general functions frequently required in developing application software. In other words, “framework” serves as a model of an application. By using this framework when developing application software, only a unique portion is needed to be developed. Thereby, the efficiency in developing application software can be improved.

Moreover, since only the view generating part 51 depends on the data to be provided (target data), in other words, since only the view generating part 51 corresponds to the unique portion, specific operations such as obtaining an attribute of the target data or adding an attribute to a view are needed to be developed for a view generation program with respect to each target data. The interface part for receiving a request for generating a view from the view generation managing part 53 is built into the framework.

Accordingly, only the view generation program with respect to the data to be provided to the user (target data) is needed to be developed based on the above-described framework of the data obtaining function according to an embodiment of the present invention. Thus, the data processing apparatus 200n can flexibly respond to changes in the data to be provided to the user (target data) or the data managed in the data processing apparatus 200n or the system connected to the data processing apparatus 200n. Thereby, the time for changing a function or installing a new function can be shortened.

Next, an exemplary operation conducted when generating a view with the data obtaining function which is developed based on a framework according to an embodiment of the present invention is described.

FIG. 22 is a schematic diagram showing an example of an operation conducted when generating a view having a generalized data obtaining function according to an embodiment of the present invention.

In the data processing apparatus 200n, upon receiving view identifying data (e.g., view name), the view identifying data is transmitted to the view generation managing part 53 for requesting execution of the view generation program corresponding to the view identifying data (execution request) (S501).

The view generation managing part 53 uses the view generation managing component 83 to search for a view generation program corresponding to the received view identifying data in the view generation program managing table 53t (Step S502). In a case where a view generation program corresponding to the view identifying data is registered, the view generation managing part 53 requests the interface of the view generating part 51 to activate the corresponding view generation program. In other words, the view generation managing part 53 requests the view generating part 51 to generate a view (Step S503).

The interface of the view generating part 51, upon receiving the view generation request, activates a view generation program (loads a program of a view to a main storage part 12 (e.g., RAM))) using the view identifying data obtained from the view generation managing part 53 as a parameter of the view generation program (Step S504).

In accordance with the view generation program activated in response to the view generation request, the view generating part 51 uses the view generating component 81 to obtain one or more attributes of data (e.g., user name) from user data managed in the data processing apparatus 200n or the data managed in the system connected to the data processing apparatus 200n (Step S505).

Then, the view generating part 51 uses the view generating component 81 adds the obtained attributes to a prepared template of a view including program codes for realizing a data obtaining function (program codes independent from the data to be obtained (target data)) (Step S506). Although the process of obtaining the attributes (Steps S505) and the process of adding the attributes (Steps S506) are performed on plural attributes at a single time, the process of obtaining the attributes and the process of adding the attributes may be repeatedly alternately performed one attribute at a time.

The view generating part 51 transmits the view generated by the view generating component 81 to the data inputting part 54 of an application or the user interface (UI) 41 via the interface of the view generating part 51 or the view generation managing part 53 (Step S507-S509).

Then, the data inputting part 54 of an application or an application executing the user interface (UI) 41 requests the view executing part 52 to execute the view. Accordingly, the view executing part 52 activates the view (i.e. loads the view to the main storage part 12 (e.g., RAM), to thereby enable input of data obtained by the activated view.

<Method of Obtaining Target Data from Plural Types of Data>

The data obtaining function according to an embodiment of the present invention may obtain necessary data (target data) from plural types of data managed in the data processing apparatus 200n or the data managed in the system connected to the data processing apparatus 200n (e.g., user data, document data).

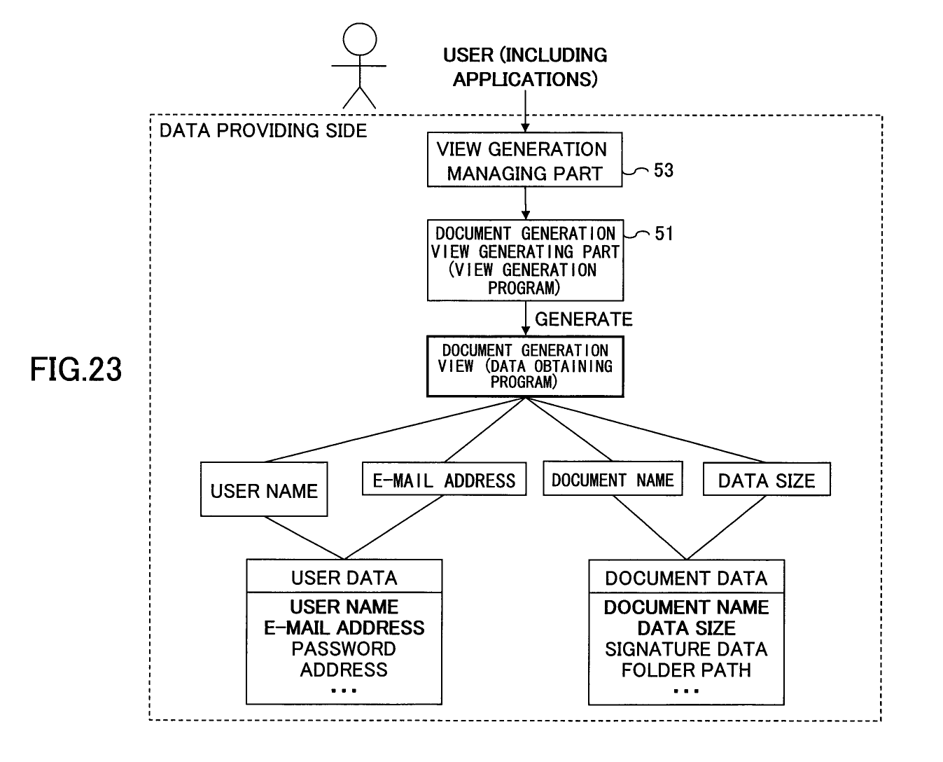

Next, a method of obtaining target data from plural types of data with the data obtaining function according to an embodiment of the present invention is described with reference to FIG. 23.

FIG. 23 is a schematic diagram showing an example of collectively obtaining data from plural types of data according to an embodiment of the present invention.

With reference to FIG. 23, in a case of handling document data (e.g., name of preparer of document, document name) managed in the data processing apparatus 200n or in the system connected to the data processing apparatus 200n, a document preparation data obtaining function component is plugged in to an existing data obtaining function component. The document preparation data obtaining function component includes a document preparation view generation program that generates a document preparation view for obtaining document preparation data. As a result, a document preparation view generation program and a corresponding document preparation view identifying data are added (registered) to the view generation managing part 53 as a new data obtaining function.

The registered document preparation view generation program is activated by the view generation managing part 53. Accordingly, the document preparation view generation program obtains attributes such as “user name” or “e-mail address” from the user data along with attributes such as “document name” or “data size” from the document data and generates a document preparation view based on the obtained attributes.

The generated document preparation view is executed by the view executing part 52. Accordingly, the document preparation view obtains necessary data (target data) from the user data and the document data by referring to the “user name”, “e-mail address”, “document name”, and “data size”.

With the above-described data obtaining function according to an embodiment of the present invention, data to be provided to the user (target data) can be obtained from plural types of data managed in the data processing apparatus 200n or plural types of data managed in the system connected to the data processing apparatus 200n. Accordingly, data necessary for realizing a function (a series of steps including an input step, a process step, and an output step (workflow)) of the data processing apparatus 200n can be flexibly and easily obtained according to a request from the user.

### CONCLUSION

In the above-described data processing apparatus 200n according to an embodiment of the present invention, first, an execution request is transmitted from the user to an application via the user interface (UI) 41. Then, the received request including request data (view identifying data) indicative of data necessary for realizing a function (a series of steps including an input step, a process step, and an output step (workflow)) of the data processing apparatus 200n is transmitted to the view generation managing component 83.

Then, the view generation managing component 83 obtains a corresponding view generation program from the view generation program storing component 84 (e.g., view generation program managing table 53t) in accordance with the received view identifying data, and activates the obtained view generation program.

Then, the activated view generation program, functioning as the view generating component 81, obtains attributes of target data (data to be obtained by a view, that is, data to be input to the data inputting component 85 in accordance with a request from the user) from data managed in the data processing apparatus 200n or data managed in a system connected to the data processing apparatus 200n in accordance with predetermined data concerning the attributes to be obtained. Then, the view generating component adds the obtained attributes to an existing view, to thereby generate a new view (data obtaining function).

Then, the view generated by the view generating component 81 is executed by the view executing component 82 in accordance with an execution instruction from an application. The view executing component 81, based on an execution instruction received from the data inputting component 85 or the user interface (UI) 41, executes the view and transmits data obtained from the executed view. The view obtains data corresponding to the attributes added to thereto by the view generating component 81 in the above-described view generating process.

Accordingly, the data obtained from the view via the view executing component 82 are used as data to be input to the data inputting part 85 included in an application or an application for providing the user interface (UI) 41.

Hence, the data processing apparatus 200 according to an embodiment of the present invention can achieve integrative management/operation of data managed in the data processing apparatus 200n or data managed in a system connected to the data processing apparatus 200n and enable the user to easily obtain the data managed in the data processing apparatus 200n or the data managed in the system connected to the data processing apparatus 200n.

Furthermore, the image processing apparatus 100 according to an embodiment of the present invention can also attain the same advantages as the data processing apparatus 200 since the image processing apparatus 100 can be configured having the same function configuration as that of the data processing apparatus 200.

Furthermore, the operations (steps) included in the data obtaining function according to an embodiment of the present invention can be executed with a computer by coding the operations (steps) using a suitable program language corresponding to its operating environment (platform). Furthermore, the program for executing the operations (steps) included in the data obtaining function according to an embodiment of the present invention may be stored in a computer-readable recording medium 300 for causing a computer to execute the data obtaining function.

The present invention is not limited to the specifically disclosed embodiments, and variations and modifications may be made without departing from the scope of the present invention.

The present application is based on Japanese Priority Application No. 2006-343086 filed on Dec. 20, 2006, the entire contents of which are hereby incorporated herein by reference.

What is claimed is:

1. A data processing apparatus including a data inputting part for inputting target data, a data processing part for processing the target data input by the data inputting part, and a data outputting part for outputting the target data processed by the data processing part, the data processing apparatus comprising:
an interface for receiving a request for obtaining the target data to be input to the data inputting part;
a view generating part for generating a view that obtains the target data from data managed in the data processing apparatus or data managed in a system connected to the data processing apparatus in accordance with the request received by the interface; and
a view executing part for executing the view generated by the view generating part.

2. The data processing apparatus as claimed in claim 1, further comprising:
a view generation program storing part for storing a view generation program in correspondence with view identifying data; and
a view generation managing part for registering, searching, or deleting the view generation program stored in the view generation program storing part.

3. The data processing apparatus as claimed in claim 2, wherein the view generation program storing part includes a view generation program managing table, wherein the view generation managing part searches through the view generation program managing table based on the view identifying data and activates the view generation program corresponding to the view identifying data.

4. The data processing apparatus as claimed in claim 1, wherein the view generating part obtains an attribute included in the target data from the data managed in the data processing apparatus or the data managed in the system connected to the data processing apparatus and generates the view based on the obtained attribute.

5. The data processing apparatus as claimed in claim 1, wherein the view generating part obtains a group of attributes included in the target data from the data managed in the data processing apparatus or the data managed in the system connected to the data processing apparatus and generates the view based on the obtained group of attributes.

6. The data processing apparatus as claimed in claim 1, wherein the view obtains the target data from the data managed in the data processing apparatus or the data managed in the system connected to the data processing apparatus based on an attribute included in the target data.

7. The data processing apparatus as claimed in claim 2, wherein the view generation managing part registers another view generation program in the view generation program storing part.

8. An image processing apparatus comprising:
the data processing apparatus as claimed in claim 1.

9. A data processing method including a data inputting step for inputting target data, a data processing step for processing the target data input in the data inputting step, and a data outputting step for outputting the target data processed in the data processing step, the data processing method comprising the steps of:
a) receiving a request for obtaining the target data to be input in the data inputting step;
b) generating a view that obtains the target data from data managed in a data processing apparatus or data managed in a system connected to the data processing apparatus in accordance with the request received in step a); and
c) executing the view generated in step b).

10. A computer-readable recording medium on which a program for causing a computer to execute a data processing method including a data inputting step for inputting target data, a data processing step for processing the target data input in the data inputting step, and a data outputting step for outputting the target data processed in the data processing step, the data processing method comprising the steps of:
a) receiving a request for obtaining the target data to be input in the data inputting step;
b) generating a view that obtains the target data from data managed in a data processing apparatus or data managed in a system connected to the data processing apparatus in accordance with the request received in step a); and
c) executing the view generated in step b).
